(19) United States
(12) Patent Application Publication
(10) Pub. No.: US 2024/0155284 A1
(43) Pub. Date: May 9, 2024

(54) INFORMATION PROCESSING APPARATUS AND INFORMATION PROCESSING METHOD

(71) Applicant: SONY GROUP CORPORATION, TOKYO (JP)

(72) Inventor: HISAKO SUGANO, TOKYO (JP)

(21) Appl. No.: 18/549,992

(22) PCT Filed: Jan. 18, 2022
(86) PCT No.: PCT/JP2022/001488

§ 371 Date: Sep. 11, 2023

(30) Foreign Application Priority Data
Mar. 19, 2021 (JP) 2021-046278

(51) Int. Cl. H04R 1/32; A63J 5/04; G06F 16/16

(52) U.S. Cl. CPC H04R 1/32; A63J 5/04; G06F 16/164

(57) ABSTRACT

The present technology relates to an information processing apparatus and an information processing method that make it possible to use applause of each audience member at a concert or the like. Communication is performed with a second apparatus that can control multiple recording apparatuses simultaneously, control is performed by the second apparatus, recording is performed in synchronization with the multiple recording apparatuses, and positional information regarding a position where recorded sound data has been recorded, and time information regarding a time when the sound data has been recorded are added to the sound data. The present technology can be mounted on pen lights that are used by an audience at a concert or the like.

### TECHNICAL FIELD

The present technology relates to an information processing apparatus and an information processing method, and in particular relates to an information processing apparatus and an information processing method that make it possible to use applause of each audience member at a concert or the like.

### BACKGROUND ART

PTL 1 discloses a technology to control timings to turn on and turn off pen lights used by an audience at a concert venue or the like.

### CITATION LIST

### Patent Literature

[PTL 1]
JP 2013-191357A

### SUMMARY

### Technical Problem

Applause (including call and response) of an audience of a concert is important to liven up an atmosphere of the concert. When sounds obtained by recording a concert are productized (edited), applause of an audience is an element which is important to reproduce the atmosphere of the concert. It is desirable to make it possible to use applause of each audience member at the time when an event such as a concert is held or when sounds recorded at the event is edited.

The present technology has been made in view of such a situation and makes it possible to use applause of each audience member at a concert or the like.

### Solution to Problem

An information processing apparatus according to a first aspect of the present technology is an information processing apparatus including a communication section that communicates with a second apparatus that is able to control multiple recording apparatuses simultaneously, a recording section that is controlled by the second apparatus, and is able to perform recording in synchronization with the multiple recording apparatuses, and a processing section that adds, to sound data recorded by the recording section, positional information regarding a position where the sound data has been recorded and time information regarding a time when the sound data has been recorded.

An information processing method according to the first aspect of the present technology is an information processing method of an information processing apparatus having a communication section, a recording section and a processing section, in which the communication section communicates with a second apparatus that is able to control multiple recording apparatuses simultaneously, the recording section is controlled by the second apparatus, and performs recording in synchronization with the multiple recording apparatuses, and the processing section adds, to sound data recorded by the recording section, positional information regarding a position where the sound data has been recorded and time information regarding a time when the sound data has been recorded.

In the information processing apparatus and information processing method according to the first aspect of the present technology, communication is performed with a second apparatus that can control multiple recording apparatuses simultaneously, control is performed by the second apparatus, recording is performed in synchronization with the multiple recording apparatuses, and positional information regarding a position where recorded sound data has been recorded, and time information regarding a time when the sound data has been recorded are added to the sound data.

An information processing apparatus according to a second aspect of the present technology is an information processing apparatus including a communication section that communicates with a second apparatus that is able to control multiple reproducing apparatuses simultaneously, and a sound reproducing section that is controlled by the second apparatus, and reproduces sound data in synchronization with the multiple reproducing apparatuses.

An information processing method according to the second aspect of the present technology is an information processing method of an information processing apparatus having a communication section and a sound reproducing section, in which the communication section communicates with a second apparatus that is able to control multiple reproducing apparatuses simultaneously, and the sound reproducing section is controlled by the second apparatus, and reproduces sound data in synchronization with the multiple reproducing apparatuses.

In the information processing apparatus and information processing method according to the second aspect of the present technology, communication is performed with a second apparatus that can control multiple reproducing apparatuses simultaneously, control is performed by the second apparatus, and sound data is reproduced in synchronization with the multiple reproducing apparatuses.

### BRIEF DESCRIPTION OF DRAWINGS

FIG. 1 is a figure illustrating an example of a configuration of an embodiment of a venue production system to which the present technology is applied.

FIG. 2 is a figure illustrating an example of an external appearance of a child device.

FIG. 3 is a configuration diagram illustrating an internal configuration of the child device.

FIG. 4 is a figure illustrating an example of some seats at a concert venue.

FIG. 5 is a configuration diagram illustrating a configuration of a parent device.

FIG. 6 is a figure for explaining an overview of the present technology.

FIG. 7 is a figure for explaining an applause recording functionality of the venue production system.

FIG. 8 is a figure illustrating an example of header information added to sound data.

FIG. 9 is a block diagram depicting a configuration example of an applause recording apparatus for implementing processes of the applause recording functionality.

FIG. 10 is a flowchart illustrating a processing procedure to be performed when the applause recording functionality is used.

FIG. 11 is a figure for explaining an applause reproduction functionality of the venue production system.

FIG. 12 is a block diagram illustrating a configuration of an applause reproducing apparatus for implementing processes of the applause reproduction functionality.

FIG. 13 is a flowchart illustrating a processing procedure to be performed when the applause generation functionality is used.

FIG. 14 is a figure for explaining a sound data transmission functionality.

FIG. 15 is a diagram for explaining virtual sound generation.

FIG. 16 is a block diagram depicting a configuration example of an editing apparatus that edits applause data.

FIG. 17 is a figure for explaining a processing procedure of the virtual sound generation in FIG. 15.

FIG. 18 is a figure for explaining virtual sound generation in a third concert mode.

FIG. 19 is a block diagram depicting a configuration example of a sound reproducing apparatus that generates sound data.

FIG. 20 is a figure for explaining a processing procedure of the virtual sound generation in FIG. 18.

### DESCRIPTION OF EMBODIMENT

Hereinbelow, an embodiment of the present technology are explained with reference to the figures.

### <Embodiment of Venue Production System>

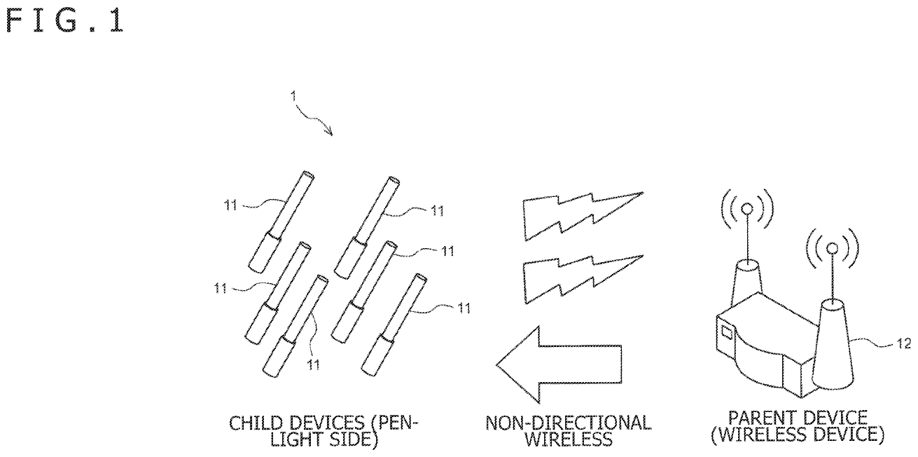

FIG. 1 is a figure illustrating an example of the configuration of an embodiment of a venue production system to which the present technology is applied.

A venue production system 1 in FIG. 1 has child devices 11 and a parent device 12. For example, the child devices 11 are pen lights that many audience members individually use at a concert venue or the like, and function as recording apparatuses and reproducing apparatuses. The child devices 11 and the parent device 12 are configured to be capable of wireless communication, and the parent device 12 (a second apparatus that can control the child devices 11 simultaneously) transmits signals to the child devices 11 by non-directional wireless communication. The parent device 12 transmits signals to the child devices 11 to thereby synchronously control timings of the child device 11 to turn on the lights, timings of the child device 11 to record sounds, timings of the child device 11 to reproduce sounds (emit sounds), and the like. Note that, in some cases such as a case of a large concert venue or the like, there may be one or more relays that are interposed between the child devices 11 and the parent device 12 to relay wireless communication. The venue production system 1 to which the present technology is applied can be used not only at a concert venue, but at any venue of any event such as a music concert or a play where people gather. It is supposed hereinbelow that the event is a music concert (called a concert, simply), and people who participate in the event as singers, players of musical instruments, and the like are called performers. Performance includes not only the performance of musical instruments, but also singing voices, talking voices, and the like of the performers.

### (Configuration of Child Devices 11)

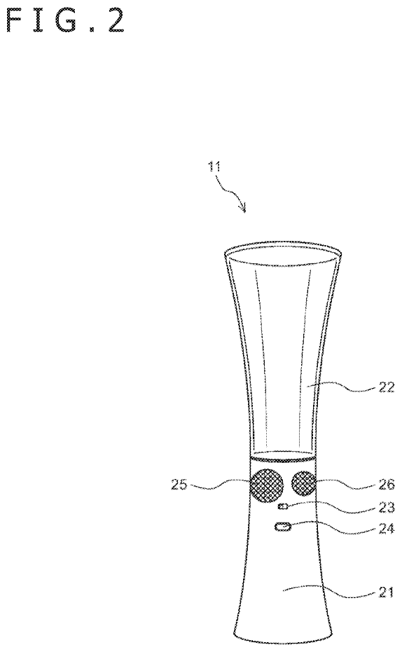

FIG. 2 is a figure illustrating an example of an external appearance of a child device 11. The child device 11 has a columnar shape as a whole, and has a grip section 21 on a base-end side where a user who is an audience member of a concert grips, and a light-emitting section 22 that emits light. Note that audience members in an audience of a concert who carry the child devices 11 are called users. A power supply switch 23, a manipulating section 24, a speaker 25, a microphone 26, and the like are arranged on the grip section 21. The power supply switch 23 is used to turn on and off the power supply of the child device 11. The manipulating section 24 represents a manipulation button, a manipulation switch, and the like that are manipulated by the user, other than the power supply switch 23. Although the illustration of the manipulating section 24 is simplified in FIG. 2, and only one push button is illustrated, this is not the sole example. The manipulating section 24 includes various types of buttons or switches for the user to perform manual manipulation to execute and stop light emission (turning on) of the light-emitting section 22, switch the luminescent color, brightness, and flashing intervals of the light-emitting section 22, execute and stop sound recording, and execute and stop sound reproduction. The speaker 25 (sound reproducing section) reproduces (outputs), as sounds, sound data of applause and the like that has been stored in advance on a storage section mentioned later. The microphone 26 (sound acquiring section) senses (receives) sounds such as applause of a user during a concert, and stores the sounds as sound data on the storage section mentioned later. The light-emitting section 22 causes light from a light source such as an LED to be diffused, and entirely emits light. Note that the present technology can be applied to devices not like the pen-light child device 11 having the light-emitting section 22 as in FIG. 2.

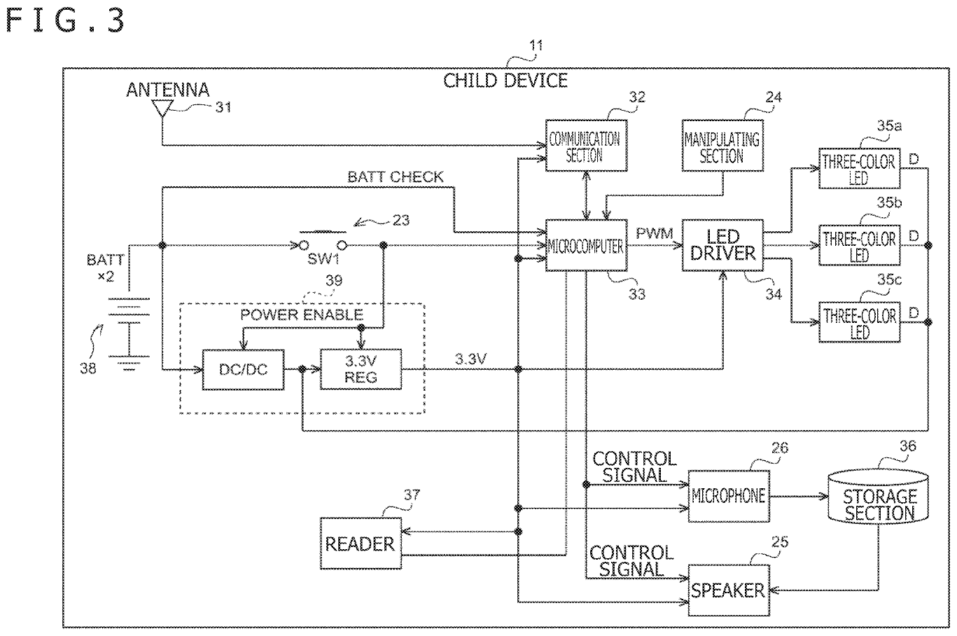

FIG. 3 is a configuration diagram illustrating an internal configuration of the child device 11. In FIG. 3, the child device 11 includes the power supply switch 23, manipulating section 24, speaker 25, and microphone 26 that are depicted also in FIG. 2, and an antenna 31, communication section 32, control section (microcomputer) 33, LED driver 34, three-color LEDs 35a, 35b, and 35c, storage section 36, reader 37, battery 38, and power supply section 39 that are not depicted in FIG. 2.

The power supply switch 23 is switched to an ON state or an OFF state by user manipulation. In a case where the power supply switch 23 is in the OFF state, electric power supply from the power supply section 39 to each section in the child device 11 is not performed, and the child device 11 as a whole is in the stopped state. When the power supply switch 23 is turned on, electric power supply from the power supply section 39 to each section in the child device 11 is performed, and each section of the child device 11 becomes operable.

The manipulating section 24 supplies an instruction according to manual manipulation of the user to the control section 33. Contents of instructions from the manipulating section 24 to the control section 33 regarding light emission of the light-emitting section 22 (see FIG. 2) includes instructions for turning on/off, luminescent color, brightness, and flashing frequency of light emission of the light-emitting section 22 by the three-color LEDs 35a, 35b, and 35c (called light emission instructions, simply), and the like. Contents of instructions regarding the speaker 25 includes instructions for reproduction (sound emission) of sound data (sound signals) stored on the storage section 36 with the speaker 25 (called sound reproduction instructions, simply), and the like. Contents of instructions regarding the microphone 26 includes instructions for recording of sound data received at the microphone 26 on the storage section 36 (called sound recording instructions, simply), and the like. Note that contents of instructions that can be given by manual manipulation of the user on the manipulating section 24 in those types of instructions contents may be only a part of the contents or may include other instruction contents.

The speaker 25 is a sound output section that outputs (reproduces) sound data as sounds, and is switched to a reproduction executed state and a reproduction stopped state according to control signals from the control section 33. In the reproduction stopped state, the speaker 25 does not perform reproduction (sound emission) of sound data. In the reproduction executed state, the speaker 25 performs reproduction (sound emission) of sound data stored (stored) on the storage section 36.

The microphone 26 is switched to a recording executed state and a recording stopped state according to control signals from the control section 33. In the recording stopped state, the microphone 26 does not perform storage (recording) of sound data on the storage section 36. In the recording executed state, the microphone 26 performs storage of received sound signals as sound data on the storage section 36.

The antenna 31 receives signals from the parent device 12 or transmits signals to the parent device 12. The communication section 32 performs transmission and reception of various types of signals (various types of instructions and various types of data) via the antenna 31 to and from the parent device 12 by communication conforming to predetermined wireless communication standards such as Bluetooth (registered trademark) or a wireless LAN. The communication section 32 supplies signals acquired from the parent device 12 to the control section 33. The communication section 32 transmits, to the parent device 12 via the antenna 31, various types of signals that are supplied from the control section 33 and are for the parent device 12. Contents of instructions from the parent device 12 that are supplied from the communication section 32 to the control section 33 includes a light emission instruction, a sound reproduction instruction, a sound recording instruction, and the like, similarly to the contents of instructions from the manipulating section 24.

The control section 33 controls light emission, sound reproduction, and sound recording on the basis of instructions from the parent device 12 or instructions from the manipulating section 24. In light emission control, the control section 33 sends, to the LED driver 34, a control signal for driving the three-color LEDs 35a, 35b, and 35c. The LED driver 34 drives the three-color LEDs 35a, 35b, and 35c on the basis of the control signal from the control section 33. Thereby, the luminescent color, brightness, flashing intervals, and the like of the three-color LEDs 35a, 35b, and 35c are controlled in accordance with an instruction from the parent device 12 or the manipulating section 24.

In sound reproduction control, the control section 33 sends, to the speaker 25, a control signal for driving the speaker 25. The speaker 25 is switched to a reproduction executed state and a reproduction stopped state on the basis of control signals sent from the control section 33. In the reproduction executed state, the speaker 25 performs reproduction (sound emission) of sound data stored on the storage section 36. In the reproduction stopped state, power supply (electric power supply) to the speaker 25 is stopped, and the speaker 25 does not execute reproduction of sound data. Note that the flow of sound data from the storage section 36 to the speaker 25 is omitted in the figure. Specifically, reading out of the sound data to be reproduced with the speaker 25 from the storage section 36 is performed by the control section 33, for example. The sound data read out from the storage section 36 is supplied from the control section 33 to the speaker 25. Processing such as decoding of the sound data stored on the storage section 36 in a case where the sound data has been encoded also is performed by the control section 33.

In sound recording control, the control section 33 sends a control signal for driving the microphone 26 to the microphone 26. The microphone 26 is switched to a recording executed state and a recording stopped state on the basis of control signals sent from the control section 33. In the recording executed state, the microphone 26 causes sensed sound data to be stored on the storage section 36. In the recording stopped state, power supply (electric power supply) to the microphone 26 is stopped, and the microphone 26 does not execute storage of sound data on the storage section 36. Note that the flow of sound data from the microphone 26 to the storage section 36 is omitted in the figure. Specifically, writing (storage) of sound data sensed at the microphone 26 on the storage section 36 is performed by the control section 33, for example. The sound data received at the microphone 26 is stored on the storage section 36 by the control section 33. A process of encoding in a case where the sound data that is caused to be stored on the storage section 36 is encoded is performed by the control section 33.

The reader 37 communicates with an electronic tag (IC tag) that is made closer to the reader 37 (touched by the child device 11) by an NFC (Near Field Communication) technology such as FeliCa (registered trademark), and reads out information recorded on the electronic tag.

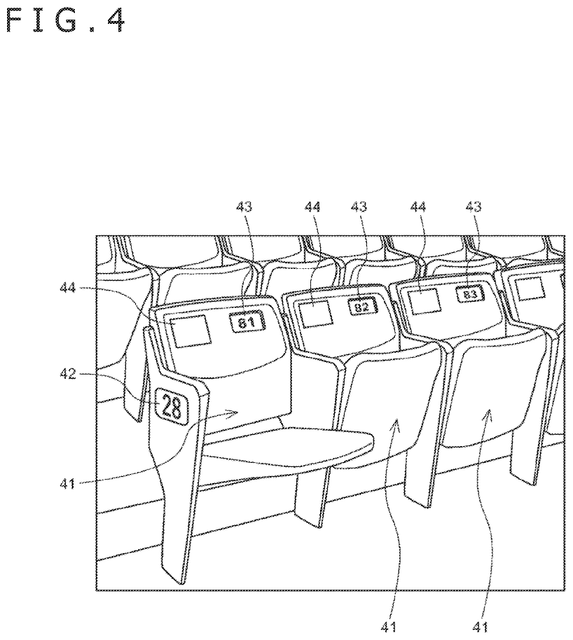

FIG. 4 is a figure illustrating an example of some seats at a concert venue. In FIG. 4, seats 41 are arranged next to each other in a row, and additionally multiple rows of such seats 41 are arranged one behind another. A reference character 42 (the number 28 is depicted in the example in FIG. 4) denotes the row number of seats with the reference character 42 arranged next to each other in a row. Reference characters 43 (the numbers 81 to 83 are depicted in the example in FIG. 4) denote the line numbers of seats with the reference characters 43. The seat number of each seat 41 is determined by the combination of a row number and a line number. An electronic tag 44 is installed at each seat 41. A seat number is recorded as identification information that identifies (the position of) each seat 41 on the electronic tag 44 of the seat 41. However, the seat number recorded on the electronic tag 44 does not have to match the seat number represented by the reference characters 42 and 43. Acquisition of seat information that identifies the position of a seat is not necessarily performed by using an electronic tag 44. Seat information that identifies the position of a seat is not necessarily a seat number.

A user who is an audience member moves to a seat with a seat number specified at the time of a ticket purchase or the like, and then touches, with a child device 11 owned by the user, an electronic tag 44 installed at the seat. That is, each user who has acquired a child device 11 by a purchase or the like before a concert brings the child device 11 carried by her/himself close to an electronic tag 44 of a seat allocated to her/himself. When the reader 37 of each child device 11 approaches an electronic tag 44, and a distance therebetween becomes so short that they can communicate with each other, a seat number recorded on the electronic tag 44 is read out by the reader 37 of the child device 11, and supplied to the control section 33. Thereby, each child device 11 recognizes the seat number of a seat where the child device 11 is to be arranged. Note that a concert is held (implemented) without a gathering of an audience at a concert venue in some cases, as mentioned later. In that case, a concert organizer staff or the like may arrange child devices 11 at seats, and implement the concert. At this time, the work to cause each child device 11 arranged at a seat to recognize the seat number of the seat may be performed by a staff or the like who arranges the child device 11 at the seat, and the work is not necessarily performed by users.

In FIG. 3, the control section 33 uses a seat number read out from an electronic tag 44 as identification information (user ID) that identifies a user who uses her/his own child device 11 in many child devices 11. The control section 33 transmits the seat number as the user ID to the parent device 12 by using the communication section 32. Thereby, the parent device 12 recognizes the seat position of the child device 11 at the concert venue on the basis of the user ID (seat number).

Here, a control section 61 of the parent device 12 specifies a broadcast mode or an ID-based mode depending on mode information in signals to be transmitted to child devices 11 in a case where the control section 61 transmits the signals for giving a light emission instruction, a sound reproduction instruction, or a sound recording instruction to the child devices 11. In a case where the control section 61 has specified the ID-based mode, the control section 61 further specifies the user ID (seat number) of a child device 11 that should receive a signal to be transmitted to the child device 11 as a valid signal, by ID-based information in the signal.

Upon receiving a signal from the parent device 12, the control section 33 of a child device 11 refers to mode information included in the signal, and assesses whether the signal is a broadcast mode signal or an ID-based mode signal.

In a case where the signal from the parent device 12 is a broadcast mode signal, the control section 33 follows a light emission instruction, a sound reproduction instruction, or a sound recording instruction included in the signal from the parent device 12.

In a case where the signal from the parent device 12 is an ID-based mode signal, the control section 33 refers to ID-based information included in the signal, and determines whether or not the ID-based information specifies the user ID (seat number) of the child device 11 of itself.

In a case where the signal is an ID-based mode signal, and the ID-based information specifies the user ID of itself, the control section 33 follows a light emission instruction, a sound reproduction instruction, or a sound recording instruction included in the signal from the parent device 12.

In a case where the signal is an ID-based mode signal, and the ID-based information does not specify the user ID of itself, the control section 33 negates the signal from the parent device 12.

Thereby, the parent device 12 can give light emission instructions, sound reproduction instructions, or sound recording instructions while limiting the receivers of the instructions to child devices 11 of particular seat positions.

The battery 38 supplies electric power to each constituent section of the child device 11 through the power supply section 39. In a case where the power supply switch 23 is in the OFF state, the power supply section 39 does not supply electric power from the battery 38 to each constituent section. In a case where the power supply switch 23 is in the ON state, electric power from the battery 38 is supplied to the speaker 25, the microphone 26, the communication section 32, the control section 33, the LED driver 34, the reader 37, and the like. Thereby, the child device 11 becomes operable.

### (Configuration of Parent Device 12)

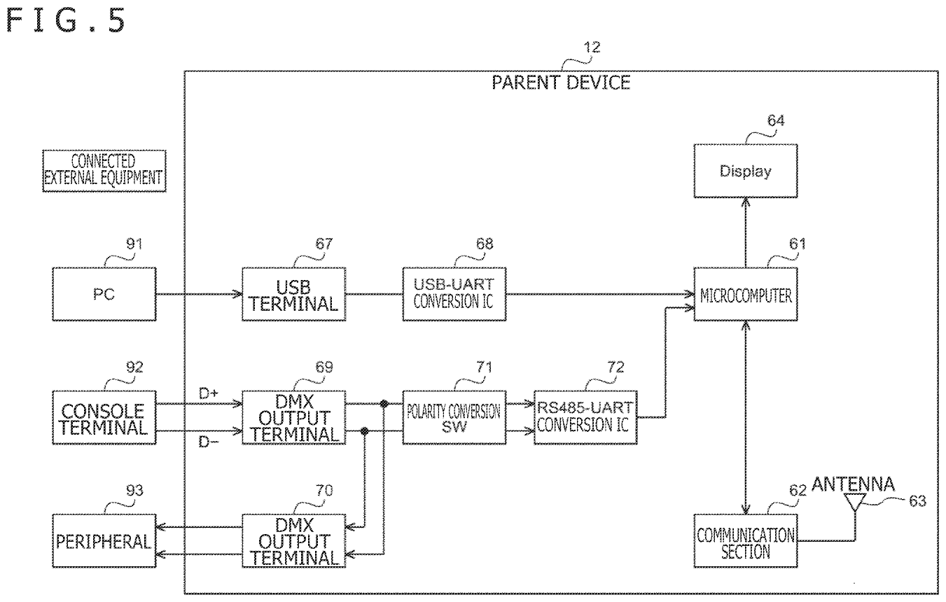

FIG. 5 is a configuration diagram illustrating a configuration of the parent device 12. In FIG. 5, the parent device 12 is connected with, as connected external equipment, a personal computer (PC) 91, a console terminal 92, and a peripheral (spotlight, etc.) 93.

The parent device 12 has the control section 61, a communication section 62, an antenna 63, a display section 64, a USB terminal 67, a conversion IC 68, a DMX input terminal 69, a DMX output terminal 70, a polarity conversion SW 71, and a conversion IC 72.

The control section 61 supplies, to the communication section 62, a signal (instruction, etc.) to be transmitted to a child device 11, for example, on the basis of a signal from the PC 91 or the console terminal 92. Contents of instructions from the control section 61 to child devices 11 includes a light emission instruction, a sound reproduction instruction, a sound recording instruction, and the like.

The communication section 62 performs transmission and reception of various types of signals (various types of instructions and various types of data) via the antenna 63 to and from child devices 11 (communication sections 32) by communication conforming to predetermined wireless communication standards such as Bluetooth (registered trademark) or a wireless LAN. The antenna 63 receives signals from the child devices 11 and transmits signals to the child device 11. The communication section 62 supplies signals acquired from the child devices 11 to the control section 61. The communication section 62 transmits, to the child devices 11 via the antenna 63, various types of signals that are supplied from the control section 61 and are for the child devices 11.

The display section 64 displays various types of information on the basis of instructions from the control section 61.

The USB terminal 67 is connected with the PC 91. The PC 91 transmits, to the parent device 12, signals of instructions for light emission, sound reproduction, sound recording, and the like of child devices 11 by using an application of the PC 91 according to user manipulation or the like. Signals input from the PC 91 via the USB terminal 67 are converted to UART signals at the conversion IC 68, and sent to the control section 61. The control section 61 supplies, to the communication section 62, signals of instructions for light emission, sound reproduction, and sound recording of child devices 11 in accordance with instructions from the PC 91, and transmits the signals to the child device 11.

The DMX input terminal 69 is connected with the console terminal 92. The console terminal 92 transmits, to the parent device 12, signals of instructions for light emission, sound reproduction, sound recording, and the like of child devices 11 according to user manipulation. The signals from the console terminal 92 include also signals for instructing the peripheral 93 connected to the parent device 12 to perform predetermined operation. The signals from the console terminal 92 are input to the DMX input terminal 69 of the parent device 12. The signals input to the DMX input terminal 69 are sent from the polarity conversion SW 71 to the conversion IC 72, converted to serial data at the conversion IC 72, and sent to the control section 61. Signals which are instructions from the console terminal 92 to the peripheral 93 are sent to the DMX output terminal 70, and sent to the peripheral 93. For example, in a case where the peripheral 93 is a spotlight used at a concert venue, an angle of the spotlight is changed on the basis of a signal from the console terminal 92.

Note that the PC 91 and the console terminal 92 can limit child devices 11 to be given respective instructions of light emission, sound reproduction, sound recording, and the like to child devices 11 corresponding to seats with some seat numbers. In that case, the control section 61 of the parent device 12 transmits, to the child devices 11, instructions from the PC 91 or the console terminal 92 as ID-based mode signals as described above, and additionally transmits, to the child devices 11 and as ID-based information, user IDs (seat numbers) of the child devices 11 that are caused to receive the instructions as valid instructions.

### <Overview of Present Technology>

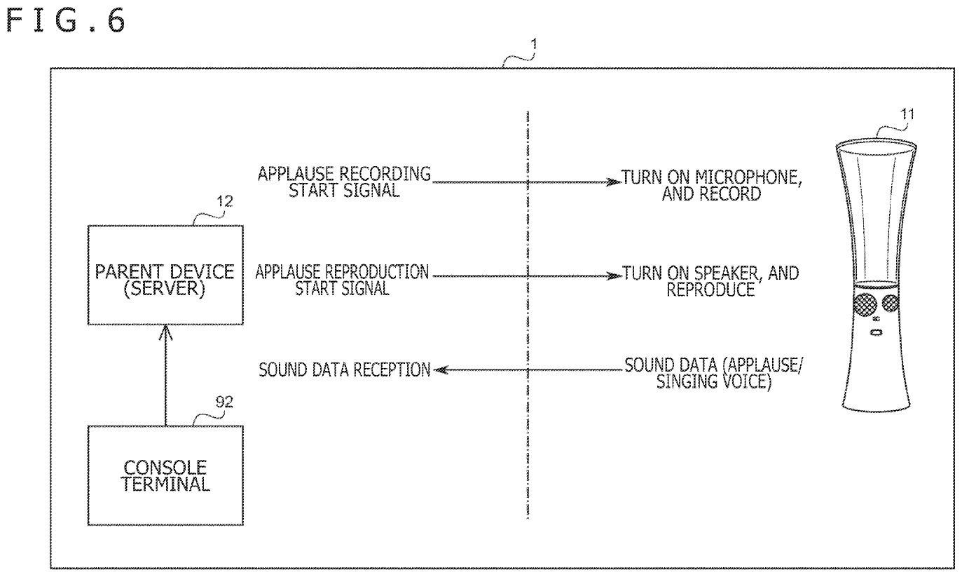

FIG. 6 is a figure for explaining an overview of the present technology. In FIG. 6, the venue production system 1 to which the present technology is applied has an applause recording functionality, an applause reproduction functionality, and a sound data transmission functionality, in addition to a functionality related to light emission of child devices 11 (light-emitting functionality). The light-emitting functionality is a functionality for causing all child devices 11 or some child devices 11 to emit light or flash in synchronization with each other or causing each child device 11 to emit light or flash, according to control according to a wireless signal from the parent device 12 or the like. Since the position of each child device 11 at a concert venue is identified by a seat number (user ID), the parent device 12 can control the light emission timing, color and the like of each child device 11 at a predetermined position by specifying the seat number. Accordingly, the light-emitting functionality allows various types of production by using light such as depiction of characters or patterns by using light at a concert venue. Since such a light-emitting functionality is well known, a detailed explanation thereof is omitted (see PTL 1 (JP 2013-191357A), for example). The present technology can also be applied to child devices 11 not having light-emitting functionalities.

The applause recording functionality is a functionality for causing all child devices 11 or some child devices 11 to record sounds (applause) of users in synchronization with each other or causing each child device 11 to record sounds (applause) of a user, according to control according to a wireless signal from the parent device 12 or the like. That is, the applause recording functionality is a functionality to turn on a microphone 26 and perform recording of applause of a user who is an audience member of a concert (recording on the storage section 36) when the child device 11 of the user receives a signal (applause recording start signal) from the parent device 12 for instructing to start applause recording. Note that it is also possible to keep the microphone 26 turned on always from the start to the end of a concert, and record applause of a user. However, if the microphone 26 is kept turned on always, the capacity of the battery of the child device 11 becomes inadequate, and there can be an unexpected situation where it becomes not possible to use the child device 11 during a concert. The memory capacity required for storing sound data of recorded applause (applause data) also increases. The amount of the recorded applause data that is transmitted after the end of the concert or the like to a concert organizer server or the like also increases. Accordingly, it is attempted to reduce the battery consumption, the memory capacity, and the amount of data to be transmitted, by turning on the microphone 26 only during applause periods in which applause of an audience member is estimated to occur during a concert and recording the applause only during those applause periods.

The applause reproduction functionality is a functionality for causing all child devices 11 or some child devices 11 to reproduce applause of users in synchronization with each other or causing each child device 11 to reproduce applause of a user, according to control according to a wireless signal from the parent device 12 or the like. That is, the applause reproduction functionality is a functionality to turn on a speaker 25 and perform reproduction (sound emission) of applause data stored on the storage section 36 when the child device 11 of a user receives a signal (applause reproduction start signal) from the parent device 12 for instructing to start applause reproduction. Since the speaker 25 is turned on only in applause periods according to this applause reproduction functionality, the battery consumption is reduced. Note that applause data to be reproduced by the applause reproduction functionality is not necessarily applause data stored on the storage section 36. Applause data of a user that keeps being transmitted to a child device 11 in real time through a communication network such as a network may be reproduced.

The sound data transmission functionality is a functionality to transmit applause data stored on the storage section 36 of a child device 11 to the parent device 12, the PC 91 connected to the parent device 12, or any server (concert organizer server).

These applause recording functionality, applause reproduction functionality, and sound data transmission functionality are used as appropriate according to the mode of a concert. Note that sound data recorded by each child device 11 by using the applause recording functionality, and sound data reproduced by each child device 11 by using the applause reproduction functionality are called applause data since they are mainly sound data of applause of a user owning the child device 11. However, those pieces of applause data may include sounds other than applause.

Modes of concerts include, as a first concert mode, a typical mode (audience-attended concert) where an audience is gathered at a concert venue, and a concert is held. As a second concert mode, there is a special mode (audience-unattended concert) in which a concert is held without gathering an audience at a concert venue. As a third concert mode, there is a mode (virtual concert) in which a concert is held at a concert venue (virtual venue) in a virtual space by using a VR (virtual reality) or AR (augmented reality) technology.

In the first concert mode (audience-attended concert), the applause recording functionality of the venue production system 1 allows recording of applause of each user during a concert. Since the seat number of a seat allocated to each user owning a child device 11 is acquired with the child device 11 from the electronic tag 44, it is identified at which position in a concert venue sound data was recorded, by using the seat number as positional information regarding the child device 11 (sound recording). Applause data recorded with each child device 11 by using the applause recording functionality is collected by the parent device 12, the PC 91 connected to the parent device 12, or the server (concert organizer server) connected to a communication network such as the Internet by using the sound data transmission functionality after the end of the concert or the like. Sound data obtained by recording the performance of a concert (sound data accompanied by video data or sound data not accompanied by video data) is distributed in the form of a recording medium such as CD (Compact Disc) or DVD (Digital Versatile Disc) for a fee or for free, or distributed through a communication network such as the Internet, in some cases. It becomes possible in that case to edit main sound data (performance data) obtained by recording the performance to mix data of applause of an audience that has occurred at particular times and in particular areas, and so on to produce the atmosphere of the concert. Such use of the applause recording functionality is possible not only in the case of the first concert mode, but also in the case of the second concert mode similarly. However, since there is not an audience in the second concert mode, applause data recorded by the applause recording functionality is sound data output from speakers 25.

The applause recording functionality allows separate recording of applause of each audience member at a concert. It becomes possible to edit applause data of an audience separately from performance data in editing of sound data obtained by recording a concert or the like, and attempt to produce various production effects using the applause data.

In the second concert mode (audience-unattended concert), by arranging a child device 11 at each seat of an audience-unattended concert venue, and holding a concert, the applause reproduction functionality of the venue production system 1 allows applause to be sent to performers. For example, applause data reproduced by the applause reproduction functionality is applause data stored on the storage section 36 in advance before the concert is held. The applause data may be data obtained by recording the actual voice of each user who purchased a ticket of a seat (each user allocated to a seat) or may be applause data selected by a user from multiple types of preset applause data. In a case where applause data of the actual voice of a user is used, the user records applause data of her/his voice in advance. Before the concert starts, the user sends the recorded applause data from a terminal apparatus such as a smartphone owned by the user to the PC 91 or the like by using a communication network such as the Internet. The PC 91 transmits the applause data from the user through the parent device 12 to the child device 11 of a seat allocated to the user, and causes the applause data to be stored on the storage section 36. It may be made possible for the applause data to be transmitted directly from the terminal apparatus owned by the user to the child device 11 of the seat allocated to the user bypassing the PC 91, the parent device 12, or the like. Note that applause data reproduced at each child device 11 by the applause reproduction functionality may be applause data obtained by sensing applause made in real time during a concert by a user at home or the like. Such use of the applause reproduction functionality is possible not only in the case of the second concert mode, but also in the case of the first concert mode similarly. Since users actually carry child devices 11 in a case where the applause reproduction functionality is used in the first concert mode, applause data reproduced by the applause reproduction functionality may be recorded in advance by using the microphones 26 of the child devices 11.

The applause reproduction functionality allows sound emission of applause of each audience member from the position of a seat allocated to the audience member. It is also possible to reproduce applause of each audience member at a predetermined timing for each area in a concert venue under the control of the parent device 12, and it is possible to attempt to produce various production effects by using applause of each audience member. Even at an audience-unattended concert also, performers can receive applause as if there is an audience at the venue. Fans who are not at the concert venue can feel a sense of being participating in the concert. It becomes possible to edit applause data of an audience used by the applause reproduction functionality separately from performance data in editing of sound data obtained by recording a concert or the like, and attempt to produce various production effects using the applause data.

In the third concert mode (virtual concert), a virtual child device corresponding to an actual child device 11 is arranged at each virtual seat at a virtual concert venue (virtual venue) generated in a virtual space. That is, a virtual speaker corresponding to the speaker 25 of an actual child device 11 or a virtual microphone corresponding to the microphone 26 of an actual child device 11 is arranged at each virtual seat of the virtual venue.

The applause reproduction functionality in the third concert mode allows performers performing at a virtual venue to listen to virtual applause (virtual sounds) that sounds real by ear monitors or the like. Similarly, each audience member at a virtual seat also can listen to performance sounds and applause according to her/his seat positions by a headphone or the like. Such use of the applause reproduction functionality is possible similarly also in a case where it is made possible for users to which seats are allocated to listen to virtual sounds that sound real at home or the like, in the second concert mode.

The applause recording functionality in the third concert mode allows separate recording of applause data at a virtual venue of each audience member (each user) to which a virtual seat at the virtual venue is allocated. It becomes possible to edit applause data of an audience separately from performance data in editing of sound data obtained by recording a concert or the like, and attempt to produce various production effects using the applause data. Note that applause data recorded by a virtual microphone at each virtual seat recorded by the applause recording functionality in the third concert mode may be identical to applause data reproduced at a virtual speaker of each virtual seat, in some cases.

### <Applause Recording Functionality of Venue Production System 1>

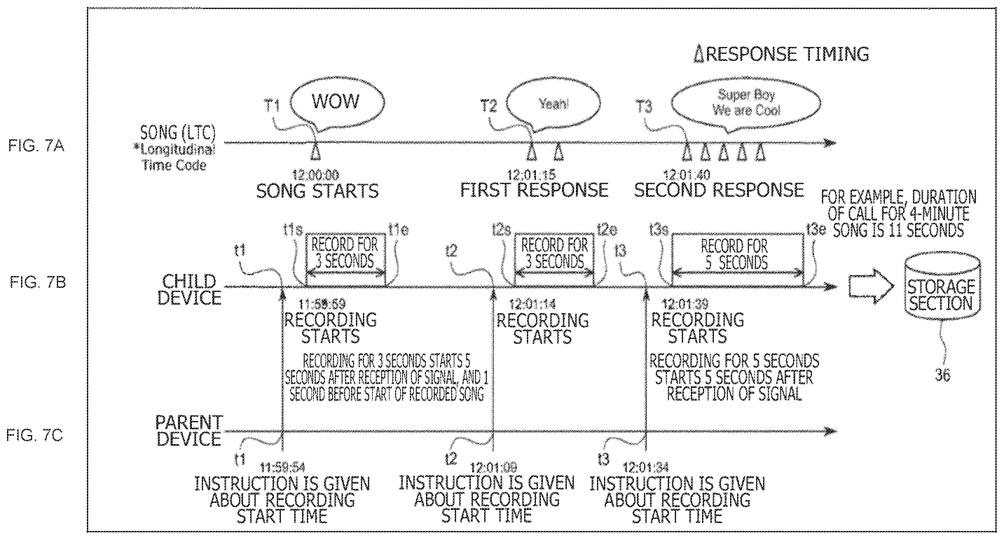

The applause recording functionality of the venue production system 1 is explained taking the case of the first concert mode as an example. FIG. 7 is a figure for explaining the applause recording functionality of the venue production system 1.

A in FIG. 7 represents hour:minute:second of a time code (LTC: Longitudinal Time-Code) added to sound data (performance data) of a song performed at a concert in a case where the performance data is recorded (sound recording). Note that the performance data can be acquired from output signals or the like of microphones and musical instruments used by performers by using apparatuses which are not depicted. The performance data is not limited to data acquired with particular apparatuses.

B in FIG. 7 represents timings of recording with the microphone 26 of a child device 11 at a predetermined seat. C in FIG. 7 represents timings of applause recording start signals transmitted from the parent device 12 to the child device 11.

Concert organizer staffs such as performers determine in advance timings and phrases of applause (call and response) about each song performed at a concert, and notify an audience of them, in some cases. In A in FIG. 7, a time T1 is the time code of the time when a predetermined song is started, and typically applause occurs at the start and end of a song even if there are no calls. In contrast, a time T2 which is a preset length of time after the time T1 is a start timing of applause according to the song. The applause at the timing of the time T2 is a response to a call by a performer.

Note that, in a case where there are responses the number of which is the same as the number of multiple consecutive calls (responses that are made at predetermined time intervals or shorter) in a song, each response in one recording period is defined as one response, and applause at the start timing of the time T2 is defined as a first response. A start timing of applause (response), the number of calls (the number of responses), and the phrases of the responses in the song are notified to the audience in advance.

A time T3 which is a preset length of time after the time T2 also is a start timing of applause according to the song. The applause at the start timing of the time T3 is defined as a second response. The start timing of the second response, the number of calls (the number of responses), and the phrases of the responses also are notified to the audience in advance. However, the timings of applause, the number of calls, and the phrases of responses may not be notified to the audience in some cases, and concert organizer staffs may determine timings at which applause is estimated (predicted) to be made, on the basis of times of interludes or lyrics of a song, on the basis of the timings, number or the like of calls to be made by performers, and so on. A period in which applause of an audience is estimated to occur is also referred to as an applause period. Note that, in FIG. 7, timings of applause after the applause at the start timing of the time T3 are omitted.

When it is a time t1, t2, or t3 which is a predetermined preset length of time before (e.g. six seconds before) the time T1, T2, or T3 which is a start timing of applause (applause period), the parent device 12 (control section 61) transmits an applause recording start signal for instructing the child device 11 to start recording of the applause. The applause recording start signals are signals specifying times (recording starting times) at which recording is started, and, for example, specify times t1s, t2s, and t3s which are five seconds after times t1, t2, and t3, respectively, as the recording start times.

Here, the time T1 at which the song is started is managed by a schedule manager or the like of the concert. The PC 91 or the console terminal 92 (hereinafter, the console terminal 92) connected to the parent device 12 acquires the information (a manipulating person inputs) to thereby grasp the time T1. Using the time T1 as a reference time, the console terminal 92 can grasp the times T1, T2, and T3 which are start timings of applause (applause periods). The console terminal 92 has stored thereon, as preset information: the song title of the song being performed; the times t1, T2, and T3 which are a predetermined preset length of time before (e.g. six seconds before) the times T1, T2, and T3 which are start timings of applause; the times t1s, t2s, and t3s at which recording of the applause started at the respective start timings of the times T1, T2, and T3 is started, and the duration of the recording (recording duration); and the numbers of applause (calls) (the numbers of consecutive calls) at the respective start timings of the times T1, T2, and T3.

When it is the time t1, t2, or t3, the console terminal 92 instructs the parent device 12 (control section 61) to transmit the applause recording start signal to the child device 11. Thereby, in C in FIG. 7, the applause recording start signals are transmitted from the parent device 12 to the child device 11 at the timings of the times t1, t2, and t3. Note that, when it is the time t1, t2, or t3, a manipulating person (an organizer staff, etc.) of the console terminal 92 may instruct, by manual manipulation, the parent device 12 to transmit the applause recording start signal to the child device 11.

In B in FIG. 7, the child device 11 (control section 33) receives, from the parent device 12, the applause recording start signals at the timings of the times t1, t2, and t3. When it is the times t1s, t2s, and t3s of the recording starts specified by the applause recording start signals, the child device 11 turns on the microphone 26 (electric power consumed state), and starts reception of applause data with the microphone 26. That is, the child device 11 starts recording at the times t1s, t2s, and t3s which are one second before the times T1, T2, and T3 which are start timings of applause.

The applause recording start signals from the parent device 12 to the child device 11 include also indications (instructions) specifying the duration of recording (recording duration), and the child device 11 (control section 33) turns off the microphone 26 (electric power un-consumed state) at the timings of the times t1e, t2e, and t3e which are the specified recording duration after the respective starts of the recording at the times t1s, t2s, and t3s, and stops reception of applause data with the microphone 26.

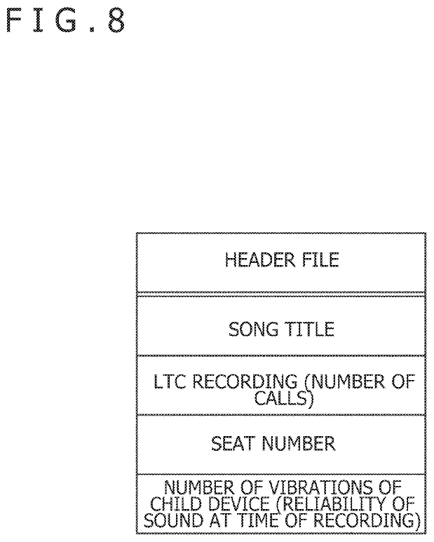

The child device 11 (control section 33) stores, on the storage section 36 and as separate applause data files, applause data acquired in the applause period from the time t1s to the time t1e, the applause period from the time t2s to the time t2e, and the applause period from the time t3s to the time t3e, respectively. At this time, the child device 11 (control section 33) adds header files (header information) including information depicted in FIG. 8 to the respective pieces of the applause data. Each header file includes, about the time when applause is recorded, a song title, an LCT record (time code), the number of calls, a user ID (seat number), and information regarding the number of vibrations of the child device 11 (vibration information regarding vibration). Note that a vibration sensor which is not depicted is mounted on the child device 11, and the number of vibrations of the child device 11 at the time of applause recording is sensed. In a case where the number of vibrations of the child device 11 at the time of applause recording is large, the reliability at the time of recording is low, and such information can be used for determining not to use the applause data, and so on. As header information, any one or more of a song title, an LCT recording (time code), the number of calls, a user ID (seat number), and information regarding the number of vibrations of the child device 11 may be added to applause data in some cases, and only the time code and the seat number may be added in some cases, for example.

Here, a performer requests a call and response from only a particular area of the concert venue in some cases. In such a case, the parent device 12 transmits, to child devices 11, an applause recording start signal specifying, as ID-based information, only seat numbers (user IDs) of the particular area by using an ID-based mode signal mentioned above. Thereby, applause recording is executed only at the child devices 11 of the specified seat numbers.

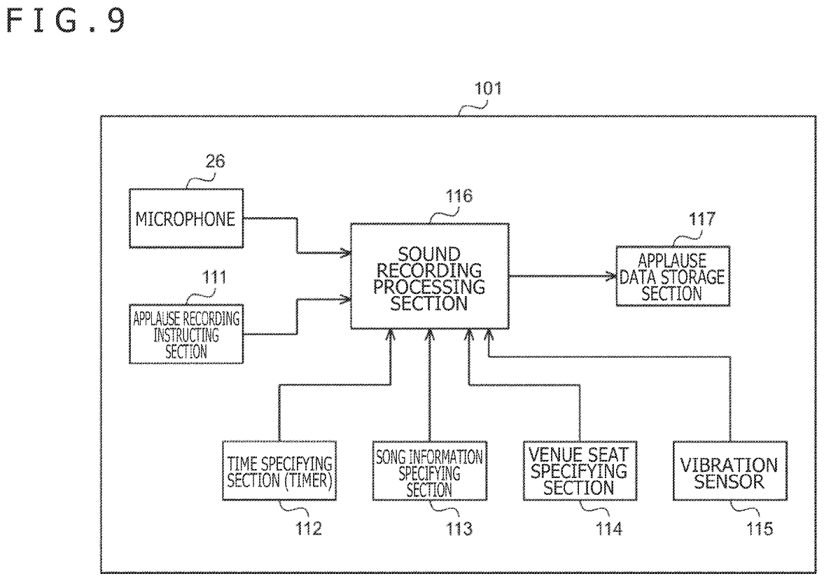

FIG. 9 is a block diagram depicting a configuration example as an applause recording apparatus for implementing processes of the applause recording functionality at the venue production system 1. Note that the configuration of and processes performed by the applause recording apparatus in FIG. 9 are explained, supposing that the applause recording functionality is used in the first concert mode (audience-attended concert).

An applause recording apparatus 101 in FIG. 9 is built by using one constituent element of the venue production system 1, and implements processes of the applause recording functionality. The applause recording apparatus 101 has the microphone 26, an applause recording instructing section 111, a time specifying section 112, a song information specifying section 113, a venue seat specifying section 114, a vibration sensor 115, a sound recording processing section 116, and an applause data storage section 117.

The microphone 26 represents the microphone 26 of a child device 11 (one predetermined child device 11) in FIG. 2 and FIG. 3. Sound signals sensed (received) with the microphone 26 (applause of a user) are supplied to the sound recording processing section 116.

The applause recording instructing section 111 is a processing section built by using constituent elements of the parent device 12 in FIG. 5 (FIG. 1) and the PC 91 or console terminal 92 connected to the parent device 12, and its processes are implemented at the parent device 12 and the PC 91 or console terminal 92. The applause recording instructing section 111 supplies an applause recording start signal for instructing the sound recording processing section 116 built by using a constituent element of the child device 11 to record sounds (applause of the user) sensed with the microphone 26. The applause recording start signal from the applause recording instructing section 111 to the sound recording processing section 116 is transmitted via wireless communication between the child device 11 and the parent device 12.

The applause recording start signal is supplied from the applause recording instructing section 111 to the sound recording processing section 116 for each applause period in which applause of an audience occurs during a concert. For example, an applause period is: a period from the start of a concert until a lapse of a preset length of time after the start of the first song; a period in which a call and response is performed during a song or the like; a period from a preset length of time before the end of a song until a lapse of a preset length of time after the start of the next song; a period from a preset length of time before the end of the last song until the end of the concert; a period in which MC (Master of Ceremonies) chat; or the like, and is estimated in advance on the basis of the set list (the order of songs, etc.) of the concert.

A timing (time) at which the applause recording instructing section 111 transmits the applause recording start signal to the sound recording processing section 116 is a time which is a preset length of time before (recording waiting time before) a recording start time at which recording is actually started. The length of the recording waiting time is several seconds, and is five seconds, for example.

The applause recording start signal from the applause recording instructing section 111 to the sound recording processing section 116 may be supplied when a manipulating person (a schedule manager, a technical staff, etc. of the concert) of the PC 91 or console terminal 92 performs predetermined manipulation for each applause period according to the status of progress of the concert in some cases, or may be supplied automatically at a time which is a preset length of time after a time at which the manipulating person performs predetermined manipulation at the start of a song or the like in some cases. The applause recording start signal from the applause recording instructing section 111 to the sound recording processing section 116 for each applause period may be supplied by any method.

Specifically, the applause recording start signal includes an indication specifying a recording start time which is a time at which recording is started, and an indication specifying recording duration which is a length of time during which recording is continued. The applause recording instructing section 111 specifies, as the recording start time, a time which is, for example, one second before the start time of a target applause period. The applause recording instructing section 111 specifies, as the recording duration, a length of time which is equal to or longer than the length of time from the recording start time until the end time of the target applause period.

Note that, instead of specifying the recording start time and the recording duration by using the applause recording start signal, the applause recording instructing section 111 may specify the recording start time and a recording end time, and what is specified by it may be any indication identifying a period during which recording is executed.

Since recording at the sound recording processing section 116 is started from the recording start time specified by the applause recording start signal from the applause recording instructing section 111, the applause recording start signal only has to be given to the sound recording processing section 116 before the recording start time. Due to transmission by the applause recording instructing section 111 of the applause recording start signal that is performed five seconds, which is the recording waiting time, before a time which is one second before the start time of each applause period, recording in the applause period is performed appropriately even in a case where a time at which the sound recording processing section 116 receives the applause recording start signal is delayed due to wireless communication from the parent device 12 to the child device 11. The recording waiting time may be a length of time other than five seconds or may be lengths of time which are different for different applause periods.

The time specifying section 112 is a timer (internal clock) built in the child device 11. The time specifying section 112 measures times, and supplies them to the sound recording processing section 116. The times are time information identifying any time points during a concert. Times are measured by a timer (internal clock) also at the parent device 12. The time specifying section 112 is synchronized with the timer of the parent device 12 before the start of a concert or the like such that at any time point it outputs the same time as a time output by the timer of the parent device 12.

The song information specifying section 113 is a processing section built by using constituent elements of the parent device 12 in FIG. 5 (FIG. 1) and the PC 91 or console terminal 92 connected to the parent device 12, and its processes are implemented at the parent device 12 and the PC 91 or console terminal 92. When the applause recording instructing section 111 instructs the sound recording processing section 116 to record applause in a predetermined applause period, the song information specifying section 113 supplies song information regarding a song performed in the target applause period to the sound recording processing section 116. The song information includes the song title and the number of times of applause (calls). The number of times of applause (calls) represents the sequence (order) of target applause periods when the applause periods are arranged in sequence from the start of the song or the start of the concert. That is, the number of times of applause represents at which position in sequence a target applause period is placed as counted from the start of a song or the start of the concert. Applause periods may be limited to periods in which responses are made to calls of performers, and, in that case, the number of times of applause may be the number of times of calls. The song information may be included in the applause recording start signal from the applause recording instructing section 111.

The venue seat specifying section 114 is a processing section built by using a constituent element of the child device 11 in FIG. 3, and its processes are implemented mainly by the control section 33 and reader 37 of the child device 11. The venue seat specifying section 114 acquires, in advance before a concert or the like, the seat number of a seat allocated to a user who uses the child device 11 of itself at a concert venue. The venue seat specifying section 114 supplies the seat number acquired in advance to the sound recording processing section 116.

The seat number is stored on the electronic tag 44 (see FIG. 4) installed at each seat of the concert venue. The user places the reader 37 of the child device 11 carried by her/him over the electronic tag 44 of the seat allocated to her/him. Thereby, the seat number recorded on the electronic tag 44 is read out by the reader 37. The venue seat specifying section 114 acquires (stores) the seat number read out by the reader 37 as a seat number (user ID) allocated to the user who uses the child device 11 of itself.

Note that acquisition of the seat number allocated to the user by the venue seat specifying section 114 is not necessarily acquisition from the electronic tag 44. For example, the venue seat specifying section 114 may acquire a seat number manually input by the user through an input section provided to the child device 11. The venue seat specifying section 114 may acquire the seat number of the user input to a terminal apparatus such as a smartphone owned by the user, through wireless communication or the like. The child device 11 on which information regarding the seat number is stored in advance may be given to the user to whom the seat with the seat number is allocated.

The seat number is positional information that identifies the position (or area) of the child device 11 at the concert venue, and, instead of the seat number, other information that identifies the position (or area) at the concert venue may be used as positional information of the child device 11, in some cases. For example, the concert venue is divided into multiple areas, and a unique area number is given to each area. An area is determined for each user where she/he views and listens at the concert venue, and the area number of the area where she/he views and listens is given to the user. Along with an area number, each user is given a unique number that does not overlap at least with unique numbers of users who view and listen in the same area. In this case, a child device 11 carried by each user acquires, as positional information, the combination of an area number and a unique number of the user. Acquisition of positional information at a child device 11 may be performed by reading out positional information similarly recorded on an electronic tag that is distributed to each user by using the reader 37 as in the case of a seat number, or the user may manually input the positional information. Other than this, in a case where positional information obtained with a GPS (Global Positioning System) technology is used as positional information of a child device 11, positional information obtained by using wireless radio waves propagated between the child device 11 and wireless nodes such as wireless LAN access points installed at multiple positions of a concert venue may be used, and so on in some cases.

The vibration sensor 115 includes, for example, an acceleration sensor mounted on the child device 11. The vibration sensor 115 senses the number of vibrations of the child device 11 during a period in which the sound recording processing section 116 is executing recording of applause, and supplies, for example, the average or maximum value of the numbers of vibrations in the period to the sound recording processing section 116.

The sound recording processing section 116 is a processing section built by using a constituent element of the child device 11 in FIG. 3, and its processes are implemented mainly by the control section 33 of the child device 11. The sound recording processing section 116 executes a recording process according to an applause recording start signal from the applause recording instructing section 111. Note that the sound recording processing section 116 may be built by using a constituent element of the parent device 12 in some cases.

That is, when a time supplied from the time specifying section 112 matches a recording start time specified by the applause recording start signal, the sound recording processing section 116 turns on the microphone 26 (supplies electric power to the microphone 26), and starts a recording process. When a time supplied from the time specifying section 112 matches a time (recording end time) which is recording duration specified by the applause recording start signal after the recording start time, the sound recording processing section 116 stops (ends) the recording process, and turns off the microphone 26.

In the recording process, the sound recording processing section 116 converts sound signals sensed (received) with the microphone 26 which are analog signals into digital signals at predetermined sampling intervals, and acquires the digital signals as applause data. The sound recording processing section 116 ends the acquisition of applause data from the microphone 26 when it is the recording end time, and stores, on the applause data storage section 117 and as one file, for example, applause data acquired from the recording start time until the recording end time. When storing the applause data on the applause data storage section 117, the sound recording processing section 116 adds a header file (header information) depicted in FIG. 8 to the applause data. A song title included in the header information is supplied from the song information specifying section 113. The song title in the header information represents the song title of a song being performed while recording of the applause data is executed. An LTC record (time code) included in the header information is supplied from the time specifying section 112. For example, the time code in the header information represents a recording start time at which the sound recording processing section 116 started the recording process (time information regarding a time when recording was performed). Note that, along with the time code in the header information or instead of the time code, the number of times of applause supplied from the song information specifying section 113 may be included in the header information. A seat number included in the header information is supplied from the venue seat specifying section 114. The seat number in the header information represents a seat position where applause data was recorded (positional information regarding a position where recording was performed). The number of vibrations of the child device included in the header information is supplied from the vibration sensor 115. For example, the number of vibrations in the header information is the average or maximum value of the numbers of vibrations of the child device 11 during a period in which recording of the applause data was executed, and represents the reliability of the recorded sound. That is, the larger the number of vibrations is, the more likely it is for the user to have moved the child device 11 hard, and accordingly the more likely it is for applause of the user to have not been recorded appropriately in the applause data.

The header information may be added to the beginning of the applause data in one applause period or may be added at predetermined time intervals. The header information may be inserted into the applause data or may be associated with applause data as data separate from the applause data. In particular, time codes (timestamps) may be added to the applause data at predetermined time intervals.

Note that the sound recording processing section 116 may encode (compress) the applause data acquired by the recording process in a predetermined format, and store the encoded applause data on the applause data storage section 117.

The applause data storage section 117 is a processing section built by using a constituent element of the child device 11 in FIG. 3, and is included in the storage section 36 of the child device 11. The applause data storage section 117 stores the applause data acquired by the recording process of the sound recording processing section 116.

The applause recording apparatus 101 mentioned above is built for each child device 11 owned by one of multiple audience members (users), and applause data of each audience member is recorded separately. If the applause recording instructing section 111 gives an instruction for recording of applause data by using the microphones 26 of some child devices 11 with seat numbers specified in the ID-based mode, it is possible to synchronously record applause data only with the child devices 11 whose user IDs are those some specified seat numbers.

### <Processing Procedure of Applause Recording Functionality>

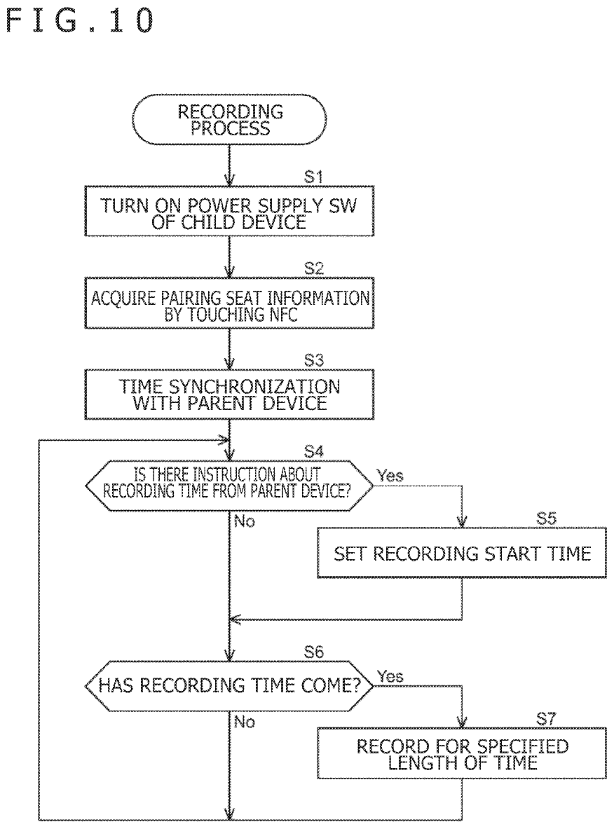

FIG. 10 is a flowchart illustrating a processing procedure to be performed when the applause recording functionality is used.

At Step S1, a user turns on the power supply switch 23 of a child device 11. The process proceeds to Step S2 from Step S1. At Step S2, the user touches, with the child device 11, the electronic tag 44 installed at a seat specified for the user, and takes in, to the child device 11, a seat number (seat information) recorded on the electronic tag 44 by NFC. Thereby, the child device 11 transmits, to the parent device 12 and as a user ID, the seat number taken in from the electronic tag 44, and is paired with the parent device 12. The process proceeds to Step S3 from Step S2.

At Step S3, the control section 33 of the child device 11 adjusts its time to the time of the parent device 12 by synchronizing the time of the built-in timer (internal clock) to the time of the parent device 12. The process proceeds to Step S4 from Step S3. At Step S4, the child device 11 determines whether or not there is an instruction about a recording start time (applause recording start signal) from the parent device 12.

In a case where it is determined at Step S4 that there is not an instruction about a recording start time, the process proceeds to Step S6. In a case where it is determined at Step S4 that there is an instruction about a recording start time, the process proceeds to Step S5.

At Step S5, the child device 11 sets the recording disclosure time instructed from the parent device 12. The process proceeds to Step S6 from Step S5. At Step S6, the child device 11 determines whether or not it is the recording start time set at Step S5.

In a case where it is determined at Step S6 that it is not the recording start time, the process returns to Step S4, and Step S4 and the subsequent step are repeated. In a case where it is determined at Step S6 that it is the recording start time, the process proceeds to Step S7.

At Step S7, the child device 11 performs recording until recording duration specified by the parent device 12 in the applause recording start signal elapses. When Step S7 ends, the process returns to Step S4, and Step S4 and the subsequent steps are repeated.

The applause recording functionality mentioned above allows separate recording of applause of each audience member at a concert. It becomes possible to edit applause data of an audience separately from performance data in editing of sound data obtained by recording a concert or the like, and attempt to produce various production effects using the applause data. The applause recording functionality can be used not only in the case of the first concert mode, but also in the case of the second concert mode or the third concert mode similarly.

### <Applause Reproduction Functionality of Venue Production System 1>

The applause recording functionality of the venue production system 1 is explained taking the case of the second concert mode (audience-unattended concert) as an example.

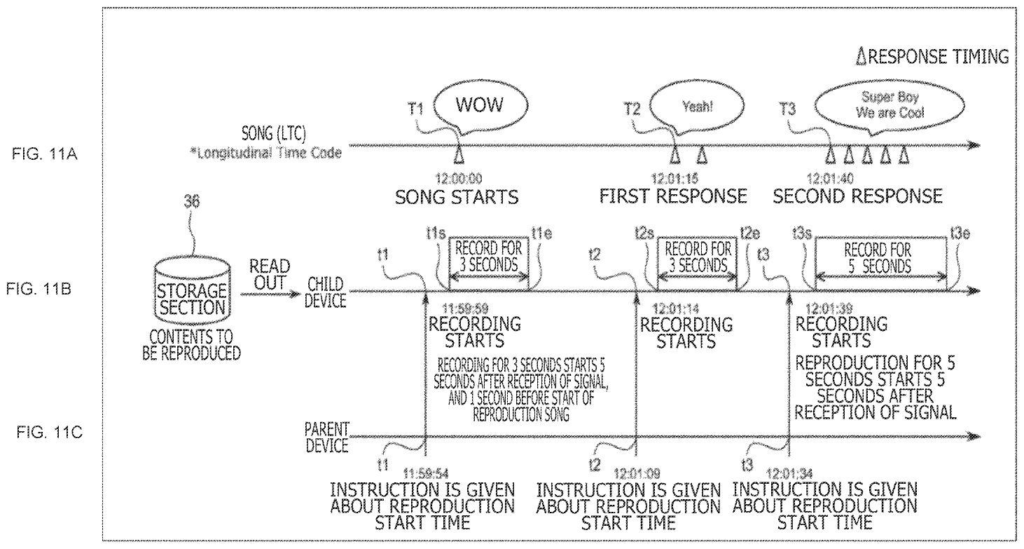

FIG. 11 is a figure for explaining the applause reproduction functionality of the venue production system 1.

A in FIG. 11 represents hour:minute:second of a time code (LTC: Longitudinal Time-Code) added to sound data (performance data) of a song performed at a concert in a case where the performance data is recorded (sound recording). Note that the performance data can be acquired from output signals or the like of microphones and musical instruments used by performers by using apparatuses which are not depicted. The performance data is not limited to data acquired with particular apparatuses.

B in FIG. 11 represents timings of reproduction of applause with the speaker 25 of a child device 11 arranged at a predetermined seat. Note that, since performance in the second concert mode is at an audience-unattended concert venue, there is not an audience. However, a user who views a video and listens to sounds of a concert distributed, for example, online is allocated as an audience member to each seat of the concert venue. The storage section 36 of a child device 11 arranged at each seat has stored thereon applause data that has been recorded in advance by a user to which the seat is allocated. A header file depicted in FIG. 8 is added to the applause data stored on the storage section 36, and the song title, time codes (times) and the like of a song for which each piece of applause data is reproduced have been determined for the applause data.

C in FIG. 11 represents timings of applause reproduction start signals transmitted from the parent device 12 to the child device 11.

In A in FIG. 11, a time T1 is the time code of the time when a predetermined song is started, and typically applause occurs at the start and end of a song even if there are no calls. In contrast, a time T2 which is a preset length of time after the time T1 is a start timing of applause according to the song. The applause at the timing of the time T2 is a response to a call by a performer.

Note that the applause at the start timing of the time T2 is defined as a first response. A start timing of applause (response), the number of calls (the number of responses), and the phrases of the responses in the song are notified to the audience in advance.

A time T3 which is a preset length of time after the time T2 also is a start timing of applause according to the song. The applause at the start timing of the time T3 is defined as a second response. The start timing of the second response, the number of calls (the number of responses), and the phrases of the responses also are notified to the audience in advance. However, the timings of applause, the number of calls, and the phrases of responses may not be notified to the audience in some cases, and organizer staffs may determine timings at which applause is estimated (predicted) to be made, on the basis of interludes or lyrics of a song, on the basis of the timings, number or the like of calls to be made by performers, and so on. Note that, in FIG. 11, timings of applause after the applause at the start timing of the time T3 are omitted.

When it is a time t1, t2, or t3 which is a predetermined preset length of time before (e.g. six seconds before) the time T1, T2, or T3 which is a start timing of applause (applause period), the parent device 12 (control section 33) transmits an applause reproduction start signal for instructing the child device 11 to start reproduction of the applause. The applause reproduction start signal is a signal specifying a time at which reproduction is started, and, for example, gives an instruction, as a reproduction start time, about a time t1s, t2s, or t3s which is five seconds after the time t1, t2, or t3, respectively.

Here, the time T1 at which the song is started is managed by a schedule manager or the like of the concert. The console terminal 92 connected to the parent device 12 acquires the information (a manipulating person inputs) to thereby grasp the time T1. Using the time T1 as a reference time, the console terminal 92 can grasp the times T1, T2, and T3 which are start timings of applause. The console terminal 92 has stored thereon, as preset information: the song title of the song being performed; the times t1, t2, and t3 which are a predetermined preset length of time before (e.g. six seconds before) the times T1, T2, and T3 which are start timings of applause (applause periods); the times t1s, t2s, and t3s at which reproduction of the applause started at the respective start timings of the times T1, T2, and T3 is started, and the duration of the reproduction (reproduction duration); and the numbers of applause (calls) (the numbers of consecutive calls) at the respective start timings of the times T1, T2, and T3.

When it is the time t1, t2, or t3, the console terminal 92 instructs the parent device 12 (control section 61) to transmit the applause reproduction start signal to the child device 11. Thereby, in C in FIG. 11, the applause reproduction start signals are transmitted from the parent device 12 to the child device 11 at the timings of the times t1, t2, and t3. Note that, when it is the time t1, t2, or t3, a manipulating person (an organizer staff, etc.) of the console terminal 92 may instruct, by manual manipulation, the parent device 12 to transmit the applause reproduction start signal to the child device 11.

In B in FIG. 11, the child device 11 (control section 33) receives, from the parent device 12, the applause generation start signals at the timings of the times t1, t2, and t3. When it is the times t1s, t2s, and t3s of the reproduction starts specified by the applause reproduction start signals, the child device 11 turns on the speaker 25 (electric power consumed state), and starts reproduction of applause data with the speaker 25. That is, the child device 11 starts reproduction at the times t1s, t2s, and t3s which are one second before the times T1, T2, and T3 which are start timings of applause. The child device 11 (control section 33) reads out applause data to be reproduced with the speaker 25 from the storage section 36 by referring to a song title and a time code in a header file. For example, the applause data to be reproduced from the time t2s is applause data having a header file having a song title which matches the song title of a song currently performed at the concert venue. In addition to this, applause data having a header file representing elapsed time since the start time of a song calculated from its time code matches or is close to the elapsed time from the start time T1 of the song until the time t2s is read out from the storage section 36, and reproduced (emitted) with the speaker 25. Note that applause data may be read out and reproduced in ascending order of times represented by time codes in applause data of the same song stored on the storage section 36.

The applause reproduction start signals from the parent device 12 to the child device 11 include also indications (instructions) specifying the duration of reproduction (reproduction duration), and the child device 11 (control section 33) turns off the speaker 25 (electric power un-consumed state) at the timings of the times t1e, t2e, and t3e which are the specified reproduction duration after the respective starts of the reproduction at the times t1s, t2s, and t3s, and stops the reproduction of applause data with the speaker 25.

Here, a performer requests a call and response from only a particular area of the concert venue in some cases. In such a case, the parent device 12 transmits, to child devices 11, an applause reproduction start signal specifying, as ID-based information, only seat numbers (user IDs) of the particular area by using an ID-based mode signal mentioned above. Thereby, applause reproduction is executed only at the child devices 11 of the specified seat numbers.

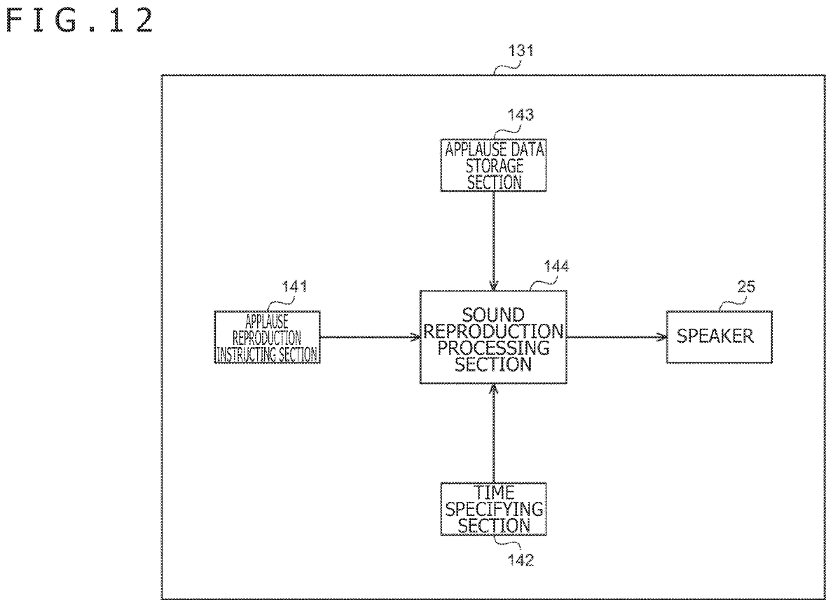

FIG. 12 is a block diagram illustrating a configuration as an applause reproducing apparatus for implementing processes of the applause reproduction functionality at the venue production system 1. Note that the configuration of and processes performed by the applause reproducing apparatus in FIG. 12 are explained, supposing that the applause reproduction functionality is used in the second concert mode.

An applause reproducing apparatus 131 in FIG. 12 is built by using a constituent element of the venue production system 1, and implements processes of the applause reproduction functionality. The applause reproducing apparatus 131 has the speaker 25, an applause reproduction instructing section 141, a time specifying section 142, an applause data storage section 143, and a sound reproduction processing section 144.

The speaker 25 represents the speaker 25 of a child device 11 (one predetermined child device 11) in FIG. 2 and FIG. 3. The speaker 25 reproduces (emits) sound signals supplied from the sound reproduction processing section 144.

The applause reproduction instructing section 141 is a processing section built by using constituent elements of the parent device 12 in FIG. 5 (FIG. 1) and the PC 91 or console terminal 92 connected to the parent device 12, and its processes are implemented at the parent device 12 and the PC 91 or console terminal 92. The applause reproduction instructing section 141 supplies an applause reproduction start signal for instructing the sound reproduction processing section 144 built by using a constituent element of the child device 11 to reproduce sounds (applause of the user) with the speaker 25. The applause reproduction start signal from the applause reproduction instructing section 141 to the sound reproduction processing section 144 is transmitted via wireless communication between the child device 11 and the parent device 12.

The applause reproduction start signal is supplied from the applause reproduction instructing section 141 to the sound reproduction processing section 144 for each applause period in which applause of an audience occurs during a concert. Since the applause periods are as mentioned above, explanations thereof are omitted.

A timing (time) at which the applause reproduction instructing section 141 transmits the applause reproduction start signal to the sound reproduction processing section 144 is a time which is a preset length of time before (reproduction waiting time before) a reproduction start time at which reproduction is actually started. The length of the reproduction waiting time is several seconds, and is five seconds, for example.

The applause reproduction start signal from the applause reproduction instructing section 141 to the sound reproduction processing section 144 may be supplied when a manipulating person of the PC 91 or console terminal 92 performs predetermined manipulation for each applause period according to the status of progress of the concert in some cases, or may be supplied automatically at a time which is a preset length of time after a time at which the manipulating person performs predetermined manipulation at the start of a song or the like in some cases. The applause reproduction start signal from the applause reproduction instructing section 141 to the sound reproduction processing section 144 for each applause period may be supplied by any method.

Specifically, the applause reproduction start signal includes an indication specifying a reproduction start time which is a time at which reproduction is started, and an indication specifying reproduction duration which is a length of time during which reproduction is continued. The applause reproduction instructing section 141 specifies, as the reproduction start time, a time which is, for example, one second before the start time of a target applause period. The applause reproduction instructing section 141 specifies, as the reproduction duration, a length of time which is equal to or longer than the length of time from the reproduction start time until the end time of the target applause period.

Note that, instead of specifying the reproduction start time and the reproduction duration by using the applause reproduction start signal, the applause reproduction instructing section 141 may specify the reproduction start time and a reproduction end time, and what is specified by it may be any indication identifying a period during which reproduction is executed.

Since reproduction at the sound reproduction processing section 144 is started from the reproduction start time specified by the applause reproduction start signal from the applause reproduction instructing section 141, the applause reproduction start signal only has to be given to the sound reproduction processing section 144 before the reproduction start time. Due to transmission by the applause reproduction instructing section 141 of the applause reproduction start signal that is performed five seconds, which is the reproduction waiting time, before a time which is one second before the start time of each applause period, reproduction in the applause period is performed appropriately even in a case where a time at which the sound reproduction processing section 144 receives the sound reproduction instruction is delayed due to wireless communication from the parent device 12 to the child device 11. The reproduction waiting time may be a length of time other than five seconds or may be lengths of time which are different for different applause periods.

The time specifying section 142 is a timer (internal clock) built in the child device 11. The time specifying section 142 measures times, and supplies them to the sound reproduction processing section 144. The times are time information identifying any time points during a concert. Times are measured by a timer (internal clock) also at the parent device 12. The time specifying section 142 is synchronized with the timer of the parent device 12 before the start of a concert or the like such that at any time point it outputs the same time as a time output by the timer of the parent device 12.

The applause data storage section 143 is a processing section built by using a constituent element of the child device 11 in FIG. 3, and is included in the storage section 36 of the child device 11. The applause data storage section 143 stores in advance applause data reproduced (emitted) with the speaker 25 by a reproduction process of the sound reproduction processing section 144.

Applause data stored on the applause data storage section 143 may be applause data obtained by a user recording her/his voice in advance before the start of a concert or the like, preset applause data of an artificially generated voice or preset applause data of the voice of a person not related to the user. In a case where a user stores applause data obtained by recording her/his own voice on the applause data storage section 143, for example, the user executes a predetermined application (software) on a terminal apparatus (recording apparatus) such as a smartphone owned by her/himself. The user records applause of each applause period in accordance with guidance of the application, and generates applause data of each applause period. Header information depicted in FIG. 8 is added to the applause data of each applause period. Note that a song title in header information represents the song title of a song performed when the applause data is to be reproduced. For example, an LTC record (time code) in header information represents a reproduction start time at which reproduction of the applause data is started. Although the reproduction start time at which the reproduction of the applause data is actually started varies depending on the status of progress of the concert, the reproduction start time of the applause data according to the plan (timetable) of the concert is added as the time code of the header information. Note that, along with the time code in the header information or instead of the time code, the number of times of applause may be included in the header information. As mentioned above, for example, the number of times of applause represents the sequence (order) of target applause periods (applause periods in which applause data is reproduced) when the applause periods are arranged in sequence from the start of the song or the start of the concert. A seat number in header information is the seat number of a seat allocated to the user, and represents a seat position where the applause data is reproduced at the concert venue. The number of vibrations of the child device 11 in header information represents the reliability of a recorded sound, and is 0 in a case where the reliability is the highest. Time codes (timestamps) may be added to the applause data at predetermined time intervals.

Applause data having header information added thereto in this manner is transmitted from a terminal apparatus of a user through a communication network such as the Internet to the concert organizer server. The applause data transmitted to the server is transmitted to a child device 11 whose user ID matches the seat number of the seat allocated to the user via the parent device 12, and stored on the applause data storage section 143. Note that, when a concert organizer staff or the like arranges child devices 11 at seats before the start of the concert, each child device 11 acquires the seat number of a seat where it is arranged from the electronic tag 44, and notifies the seat number as a user ID to the parent device 12.

In a case where preset applause data of artificially generated voice or preset applause data of the voice of a person not related to a user is stored on the applause data storage section 143, for example, the user accesses the concert organizer server, and specifies applause data to be reproduced in each applause period. Note that it may be made possible for a user to select any applause data to be reproduced in each applause period from multiple types of applause data that represents different phrases or the like, for example. The server adds header information in FIG. 8 to applause data of each applause period specified by the user. Applause data having header information added thereto is transmitted to a child device 11 whose user ID matches the seat number of the seat allocated to the user, and stored on the applause data storage section 143.

The sound reproduction processing section 144 is a processing section built by using a constituent element of the child device 11 in FIG. 3, and its processes are implemented mainly by the control section 33 of the child device 11. The sound reproduction processing section 144 executes a reproduction process according to an applause reproduction start signal from the applause reproduction instructing section 141. Note that the sound reproduction processing section 144 may be built by using a constituent element of the parent device 12 in some cases.

That is, when a time supplied from the time specifying section 142 matches a reproduction start time specified by the applause reproduction start signal, the sound reproduction processing section 144 turns on the speaker 25 (supplies electric power to the speaker 25), and starts a reproduction process. When a time supplied from the time specifying section 142 matches a time (reproduction end time) which is reproduction duration specified by the applause reproduction start signal after the reproduction start time, the sound reproduction processing section 144 stops (ends) the reproduction process, and turns off the speaker 25.

In the reproduction process, the sound reproduction processing section 144 reads out, from the applause data storage section 143, applause data having, as a time code in header information, a reproduction start time specified by an applause reproduction start signal from the applause reproduction instructing section 141. Note that the applause reproduction instructing section 141 specifies, by the applause reproduction start signal, a reproduction start time corresponding to a predetermined applause period with an intension of reproducing applause data of the target applause period stored on the applause data storage section 143. The reproduction start time specified by the applause reproduction start signal, and the time code in the header information added to the applause data of the target applause period stored on the applause data storage section 143 differ due to differences between the status of progress of the concert and the plan. Accordingly, the sound reproduction processing section 144 may read out, from the applause data storage section 143, applause data that is included in applause data of applause periods stored on the applause data storage section 143, is applause data of an applause period that has not been reproduced, and has the earliest time added as a time code in the header information (or applause data having header information to which a time closest to the specified reproduction start time is added). Alternatively, the sound reproduction processing section 144 may count the number of times of supply of applause reproduction start signals from the applause reproduction instructing section 141, and read out, from the applause data storage section 143, applause data of an applause period at a position in order matching the number of times.

The sound reproduction processing section 144 converts the applause data read out from the applause data storage section 143 which are expressed by digital signals into analog signals, and causes the speaker 25 to reproduce (emit) the analog signals as sound signals. In a case where the applause data stored on the applause data storage section 143 is encoded, the sound reproduction processing section 144 performs a process of decoding the encoded applause data.

The applause reproducing apparatus 131 mentioned above is built for each child device 11 owned by one of multiple audience members (users) (a child device 11 arranged at a seat allocated to each user), and applause data of each audience member is reproduced separately at the position of the seat allocated to the user. If the applause reproduction instructing section 141 gives an instruction for reproduction of applause data by using the speakers 25 of some child devices 11 with seat numbers specified in the ID-based mode, it is possible to synchronously reproduce applause data only with the child devices 11 whose user IDs are those some specified seat numbers.

### <Processing Procedure of Sound Reproduction Functionality>

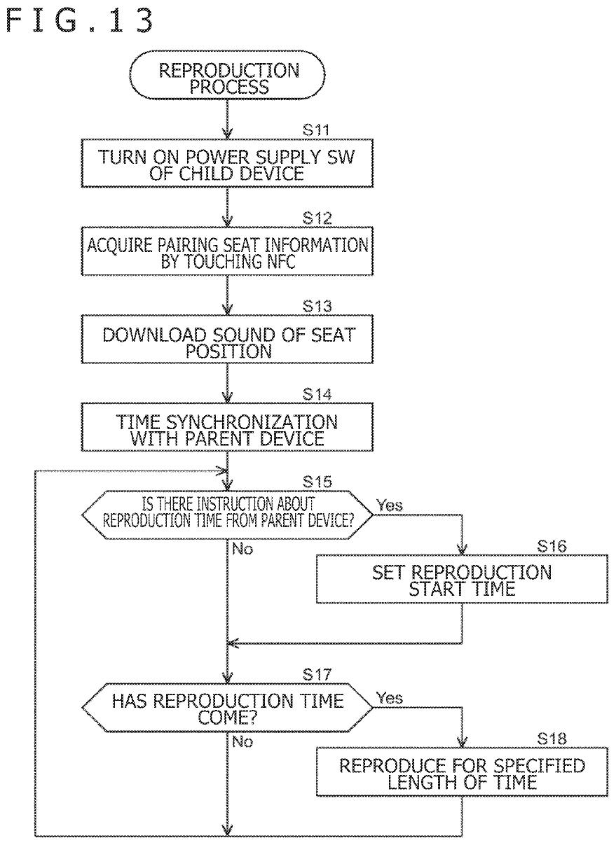

FIG. 13 is a flowchart illustrating a processing procedure to be performed when the applause generation functionality is used.

At Step S11, a concert organizer staff (hereinafter, a staff) turns on the power supply switch 23 of a child device 11. The process proceeds to Step S12 from Step S11.

At Step S12, the staff touches, with the child device 11, the electronic tag 44 installed at a seat where the child device 11 is arranged, and takes in, to the child device 11, a seat number (seat information) recorded on the electronic tag 44 by NFC. Thereby, the child device 11 transmits, to the parent device 12 and as a user ID, the seat number taken in from the electronic tag 44, and is paired with the parent device 12. The process proceeds to Step S13 from Step S12.

At Step S13, the control section 33 of the child device 11 downloads applause data corresponding to the seat number (user ID) via the parent device 12, and causes the applause data to be stored on the storage section 36. The applause data to be downloaded may be applause data uploaded to a server (the PC 91, etc.) connected to the parent device 12 in advance by a user allocated to the seat number or may be preset applause data. The process proceeds to Step S14 from Step S13.

At Step S14, the control section 33 of the child device 11 adjusts its time to the time of the parent device 12 by synchronizing the time of the built-in timer (internal clock) to the time of the parent device 12. The process proceeds to Step S14 from Step S15. At Step S15, the child device 11 determines whether or not there is an instruction about a reproduction start time (applause reproduction start signal) from the parent device 12.

In a case where it is determined at Step S15 that there is not an instruction about a reproduction start time, the process proceeds to Step S17. In a case where it is determined at Step S15 that there is an instruction about a reproduction start time, the process proceeds to Step S16.

At Step S16, the child device 11 sets the reproduction disclosure time instructed from the parent device 12. The process proceeds to Step S17 from Step S16. At Step S17, the child device 11 determines whether or not it is the reproduction start time set at Step S16.

In a case where it is determined at Step S17 that it is not the reproduction start time, the process returns to Step S15, and Step S15 and the subsequent step are repeated. In a case where it is determined at Step S17 that it is the reproduction start time, the process proceeds to Step S18.

At Step S18, the child device 11 performs reproduction of applause data until the reproduction duration specified by the parent device 12 in the applause reproduction start signal elapses. When Step S18 ends, the process returns to Step S15, and Step S15 and the subsequent steps are repeated.

The applause reproduction functionality mentioned above allows separate or synchronous reproduction of applause of each audience member at a concert at the position of a seat allocated to each audience member. It is also possible to reproduce applause of each audience member at a predetermined timing for each area in a concert venue under the control of the parent device 12 synchronously, and it is possible to attempt to produce various production effects by using applause of each audience member. Even at an audience-unattended concert also, performers can receive applause as if there is an audience at the venue. Fans who are not at the concert venue can feel a sense of being participating in the concert. It becomes possible to edit applause data of an audience used by the applause reproduction functionality separately from performance data in editing of sound data obtained by recording a concert or the like, and attempt to produce various production effects using the applause data.

Note that applause data reproduced by the applause reproduction functionality may not be caused to be stored in advance on the applause data storage section 143, but may be applause data of applause being made in real time by a user who is viewing and listening to a concert at a remote location such as her/his home. The applause reproduction functionality can be used not only in the case of the second concert mode, but also in the case of the first concert mode or the third concert mode similarly.

### <Sound Data Transmission Functionality>

The sound data transmission functionality of the venue production system 1 is explained taking the case of the first concert mode as an example.

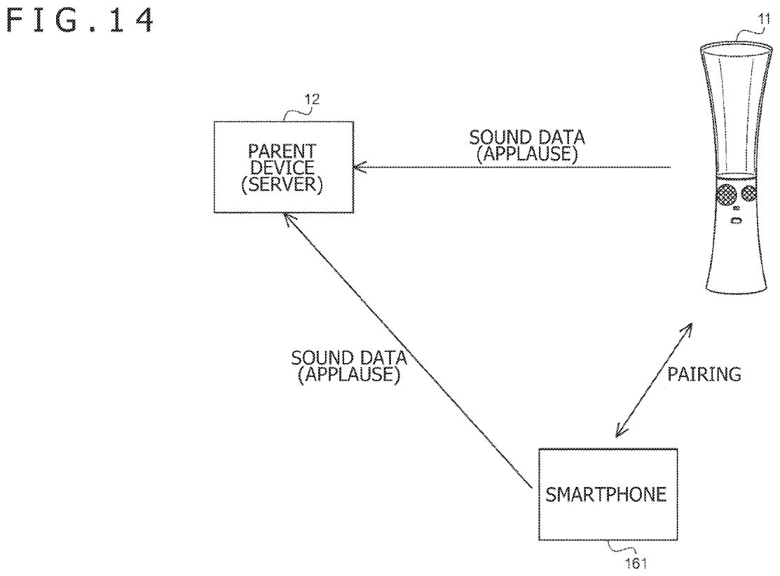

FIG. 14 is a figure for explaining the sound data transmission functionality.

In the first concert mode, applause data stored on the storage section 36 of each child device 11 by using the applause recording functionality of the venue production system 1 can be transmitted to the parent device 12, the PC 91 connected to the parent device 12, or the server (concert organizer server) connected to a network such as the Internet by using the sound data transmission functionality after the end of a concert or the like.

FIG. 14 is a figure for explaining a mode in a case where applause data is transmitted from a child device 11 to the parent device 12 (or a server).

In FIG. 14, the child device 11 can directly transmit applause data stored on the storage section 36 by wireless communication with the parent device 12 according to predetermined manipulation by the user. For example, the applause data transmitted to the parent device 12 can be transferred to the concert organizer server connected to the parent device 12. However, in this case, applause data needs to be transmitted to the parent device 12 at a concert venue.

On the other hand, the child device 11 can be connected to a smartphone 161 owned by a user by wireless communication. In view of this, the user connects the child device 11 with the smartphone 161 at home or the like after the end of the concert, and temporarily transfers applause data stored on the storage section 36 to the smartphone 161. The user can connect the smartphone 161 to the concert organizer server via a communication network such as the Internet, and transmit the applause data transferred to the smartphone 161 to the server via the communication network. Applause data can be transferred not only to the smartphone 161, but also to a mobile terminal, a home PC (personal computer) or the like that can be connected to a communication network, and then transmitted to the server.

Note that, since applause data has a seat number added thereto, it is possible to identify at which seat in the concert venue the applause data was recorded, on the basis of the seat number added to the applause data. However, this is not the sole example, and it may be made possible to identify to which seat in the concert venue and user applause data transmitted by a user corresponds, by notifying a seat number (user ID) to the server when the user transmits the applause data from her/his terminal apparatus or the like to a server via a communication network.

The sound data transmission functionality can be used not only in a case where applause data recorded by the applause recording functionality is transmitted from a child device 11 to a server or the like, but also to a case where applause data reproduced by the applause reproduction functionality is transmitted from a child device 11 to a server or the like similarly.

### <Use for Virtual Sound Generation>

Suppose that applause data of applause stored on each child device 11 by the applause recording functionality in the first concert mode is collected at the concert organizer server by the sound data transmission functionality. In a case where concert organizer staffs produce (edit) sound data obtained by recording the performance of the concert for distribution using a recording medium, distribution through a communication network, or the like, the concert organizer staffs can use seat information (seat positions) in header files (header information) added to applause data collected from the child devices 11, and generate virtual sounds that reproduce the atmosphere of the concert.

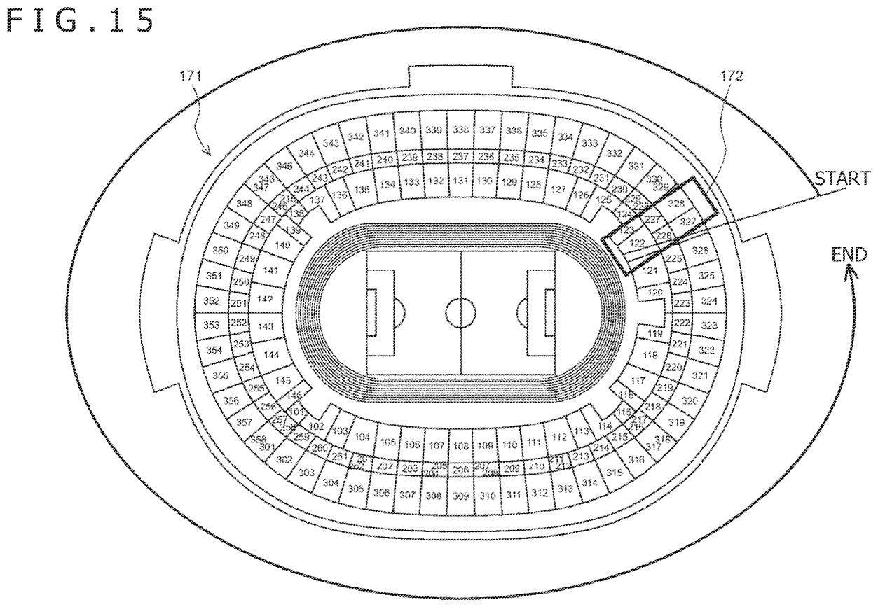

FIG. 15 is a diagram for explaining virtual sound generation. A concert venue 171 is depicted by a figure representing, as a virtual space, a concert venue that is used actually in the first concert mode. In the concert venue (virtual venue) 171 in the virtual space, virtual seats are arranged at positions as in a manner in which actual seats are arranged. An object audio (speaker) in the virtual space is arranged at each virtual seat. Applause data actually recorded by a child device 11 at each seat position is output from the object audio of each virtual seat. Thereby, applause data (virtual sounds) listened to at a certain listening position (at a seat position, on the stage, etc.) in the virtual space (virtual venue) is calculated by computation. If applause data of all the seats is reproduced synchronously, a virtual sound of a big chorus can be generated.

If applause data (virtual sounds) in a case where applause data of seats in the range of an area 172 in FIG. 15 is reproduced in the virtual space is to be generated, it is possible to generate a virtual sound like a wave by moving the area 172 from the start point around to the end point. That is, applause data of each seat can be reproduced in predetermined order (in order of seats) from seats at a predetermined start point, by using seat information in header information added to each piece of applause data. It is also possible to generate applause data (virtual sounds) in a case where applause data of only seats in an area pointed by a performer is reproduced in the virtual space.

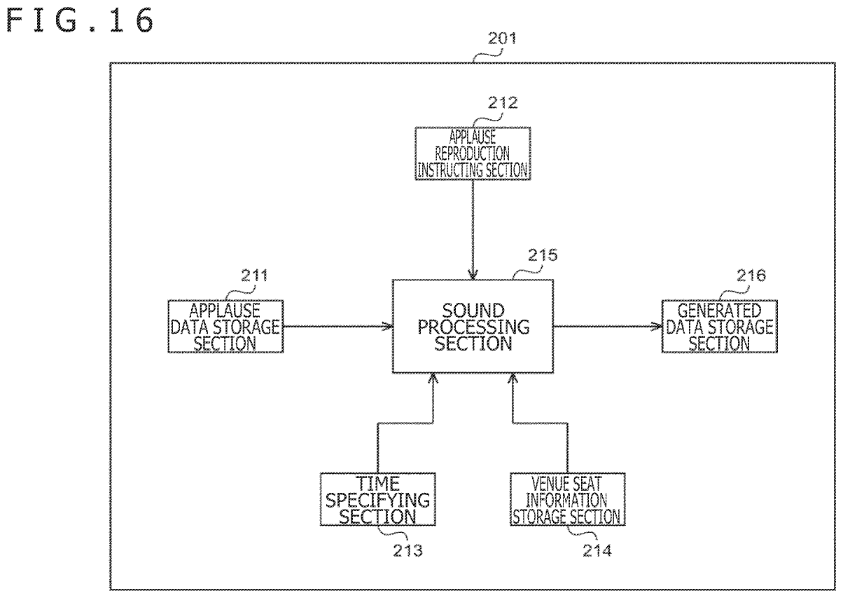

FIG. 16 is a block diagram depicting a configuration example of an editing apparatus that edits applause data in a concert. Note that it is supposed that applause data recorded by the applause recording functionality in the first concert mode or applause data used by the applause reproduction functionality in the second concert mode is edited. Editing of applause data is performed in a case where sound data obtained by recording the performance of a concert is distributed in a recording medium such as CD (Compact Disc) or DVD (Digital Versatile Disc), in a case where such sound data is distributed through a communication network, or in other cases.

An editing apparatus 201 in FIG. 16 has an applause data storage section 211, an applause reproduction instructing section 212, a time specifying section 213, a venue seat information storage section 214, a sound processing section 215, and a generated data storage section 216.

The applause data storage section 211 has stored thereon applause data of an audience member of each seat in a concert venue when a concert is held. For example, in a case where a concert is held in the first concert mode, applause data recorded for each audience member by the applause recording apparatus 101 in FIG. 9 during the concert is transmitted to the concert organizer server by the sound data transfer functionality after the concert. The applause data storage section 211 stores applause data of each audience member transmitted to the server. In a case where a concert is held in the second concert mode, applause data of each audience member reproduced by the applause reproducing apparatus 131 in FIG. 12 at the time when the concert is held is stored on the applause data storage section 211. The applause data storage section 211 supplies the stored applause data to the sound processing section 215. Note that applause data of each audience member has header information in FIG. 8 added thereto.

The applause reproduction instructing section 212 specifies for the sound processing section 215 a reproduction start time at which reproduction of applause data is started and reproduction duration during which the reproduction is continued. Along with this specification, the applause reproduction instructing section 212 specifies for the sound processing section 215 seat numbers and time codes for limiting applause data to be reproduced. Applause data to which seat numbers and time codes specified by the applause reproduction instructing section 212 have been added as header information is specified as applause data to be reproduced. Reproduction start times, reproduction duration, seat numbers, and time codes specified by the applause reproduction instructing section 212 are set by a manipulating person of the editing apparatus 201 while viewing and listening to the performance or a video of the concert. Note that, instead of specification of seat numbers, an area obtained by dividing a concert venue into multiple areas may be specified in some cases. Even in a case where an area is specified, this is expressed as specification of seat numbers.

The time specifying section 213 supplies times from the start time to the end time of the concert to the sound processing section 215.

The venue seat information storage section 214 has stored thereon venue seat information representing the position of a stage at the concert venue, the positions of seats with respective seat numbers, seat ranges included in areas in a case where the concert venue is divided into the areas, and the like. The venue seat information storage section 214 supplies the stored venue seat information to the sound processing section 215.

When a time supplied from the time specifying section 213 matches a reproduction start time specified by the applause reproduction instructing section 212, the sound processing section 215 acquires, from the applause data storage section 211, applause data to which seat numbers and time codes specified by the applause reproduction instructing section 212 have been added as header information. In a case where an area is specified instead of seat numbers by the applause reproduction instructing section 212, the sound processing section 215 refers to the venue seat information stored on the venue seat information storage section 214, and senses seat numbers included in the specified area. The sound processing section 215 acquires, from the applause data storage section 211, applause data of the sensed seat numbers.

The sound processing section 215 arranges virtual seats at positions in a concert venue (virtual venue) corresponding to a real-space concert venue that correspond to the positions of seats with respective seat numbers in the real space. In the virtual venue, the sound processing section 215 arranges applause data read out from the applause data storage section 211 as object audio of the positions of the virtual seats corresponding to the seat numbers. The sound processing section 215 generates sound data of left and right sounds that will be listened to by the respective left and right ears by using a head-related transfer function or the like, supposing that sounds of applause data reproduced (emitted) from each object audio are propagated to the respective positions of the left and right ears at a predetermined position in the virtual venue as a listening position. Thereby, the sound processing section 215 generates applause data as virtual sounds or virtual sounds (stereophonic sounds) in which sound images are localized. Note that the sound processing section 215 reproduces applause data by object audio from a reproduction start time until a reproduction end time, and generates left and right sound data (applause data) at listening positions. The sound processing section 215 causes the generated left and right applause data to which a time supplied from the time specifying section 213 is added as a time code to be stored on the generated data storage section 216.

The generated data storage section 216 stores the left and right applause data generated by the sound processing section 215. The applause data stored on the generated data storage section 216 is mixed with performance data obtained by recording the performance of a concert. Time codes are added to applause data and performance data, and applause data and performance data whose times represented by the time codes match are mixed together.

Since the editing apparatus 201 mentioned above allows reproduction of applause data of each seat stored on the applause data storage section 211 at desired timings, it is possible to generate applause data listened to at a predetermined position when applause data of only a particular area of a concert venue is reproduced at desired timings. Accordingly, as explained with reference to FIG. 15, by moving the area 172 where applause data is to be reproduced from a predetermined start point to a predetermined end position, a virtual sound like a wave can be generated.

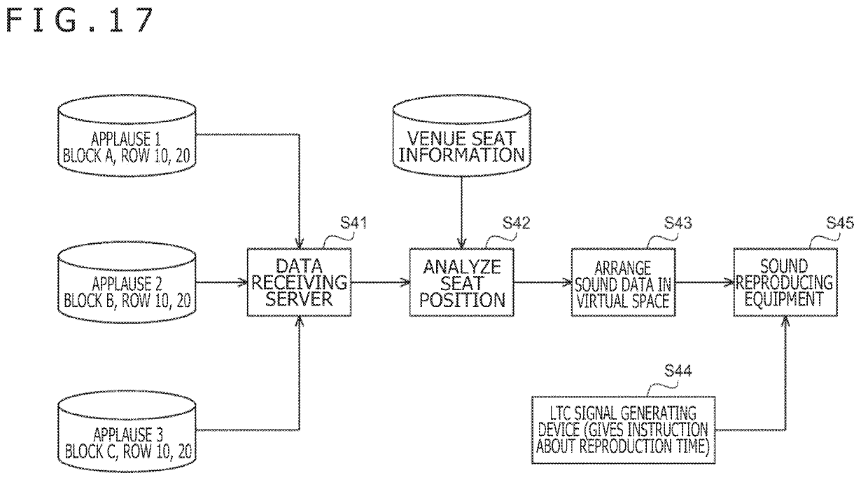

FIG. 17 is a figure for explaining a processing procedure of the virtual sound generation in FIG. 15. Note that FIG. 17 depicts a processing procedure in a case where applause data of each audience member recorded by the applause recording functionality in the first concert mode is reproduced at a timing similar to that of a concert to generate a virtual sound.

At Step S41, a data receiving server (concert organizer server) collects applause data recorded with a child device 11 of each seat in the first concert mode. At Step S42, a virtual sound generating apparatus (editing apparatus 201) analyzes a seat position at a concert venue on the basis of a seat number (seat information) included in header information of the applause data collected at Step S41. At this time, the virtual sound generating apparatus refers to venue seat information representing a relation between seat numbers and seat positions of respective seats of the concert venue.

At Step S43, the virtual sound generating apparatus arranges each piece of applause data collected at Step S41 in a concert venue (virtual venue) in a virtual space simulating the actual concert venue. At this time, each piece of applause data is arranged at a position in the virtual space corresponding to a seat position where the piece of applause data is actually recorded.

At Step S44, the virtual sound generating apparatus specifies a reproduction time by generating an LTC signal. At Step S45, the virtual sound generating apparatus reproduces each piece of applause data at the time represented by the LTC signal generated at Step S44 in the virtual space, and generates a sound at a set listening position set in the virtual space.

The virtual sound generation process mentioned above allows generation of virtual sounds in a case where applause at certain positions in a concert venue are listened to. In addition, since the editing apparatus 201 in FIG. 16 allows free editing of areas and timings where and at which applause of audience members of respective seats is reproduced at the time of a concert, it is possible to generate sounds that make it possible to attempt to create various production effects such as a virtual sound like a wave explained with reference to FIG. 15 or the like.

Note that the editing apparatus 201 in FIG. 16 does not necessarily generate virtual sounds at particular listening positions from applause data recorded by the applause recording functionality in the first concert mode or applause data used by the applause reproduction functionality in the second concert mode. The editing apparatus 201 may generate virtual sounds at particular listening positions from applause data recorded by the applause recording functionality in the second concert mode or the third concert mode or applause data used by the applause reproduction functionality in the first concert mode or the third concert mode. The editing apparatus 201 may generate virtual sounds at particular listening positions in real time during a concert from applause data planned to be reproduced by the applause reproduction functionality in the second concert mode or the third concert mode. For example, it is also possible, in the second concert mode (audience-unattended concert), to hold a concert while generating a virtual sound at the listening position of a performer in real time during the concert from applause data planned to be reproduced by the applause reproduction functionality, and allowing the performer to listen to the generated virtual sound by an ear monitor or the like. In this case, the performer can listen to applause of an audience even at the audience-unattended concert venue. Note that applause data generated at the editing apparatus 201 may not be stereophonic sounds considering the position (distance or direction) of each audience member relative to a listening position. In the first concert mode or the second concert mode, the applause reproducing apparatus 131 in FIG. 12 can also generate applause like a wave explained with reference to FIG. 15 in the actual concert venue by causing the parent device 12 to control an area of seats or time of applause data to be reproduced, in a case where applause data of each audience member is to be reproduced.

### <Virtual Sound Generation in Third Concert Mode>

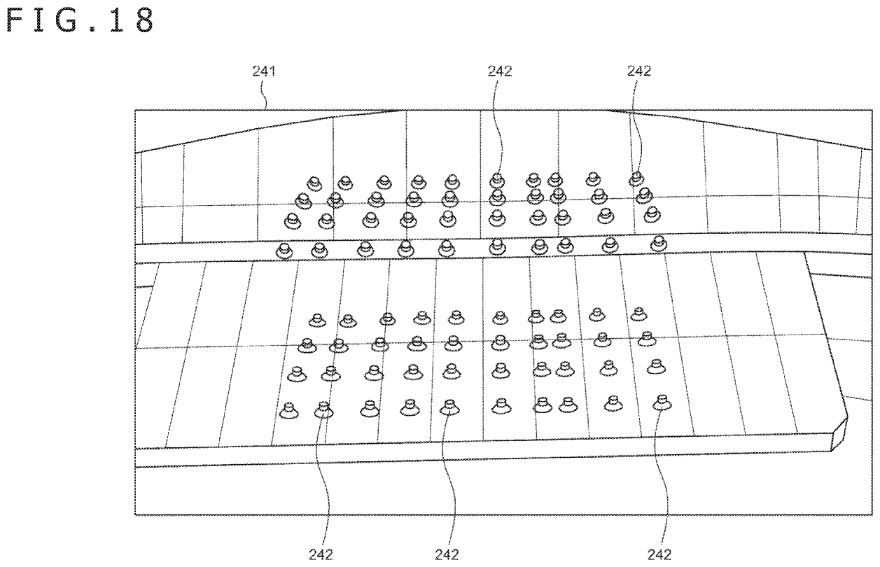

FIG. 18 is a figure for explaining virtual sound generation in the third concert mode.

In FIG. 18, a concert venue 241 is a virtual concert venue formed on a virtual space. For example, a concert at the virtual concert venue 241 is distributed online (distributed through a communication network), and seat numbers at the virtual concert venue 241 are allocated to viewers/listeners. There is almost no upper limit of the number of seats of the concert venue 241, and, for example, seat numbers are allocated to 0.7 million viewers/listeners. However, suppose that overlapping seat numbers can be allocated to multiple viewers/listeners. Suppose that ten viewer/listeners are allocated to each seat (one seat number) in a case where there are 0.7 million viewer/listeners.

A virtual child device 11 is arranged at each seat. A speaker 242 of the virtual child device 11 may output synthesized applause data of, for example, ten audience members to which the seat is allocated or may output applause data of different viewer/listeners for different songs.

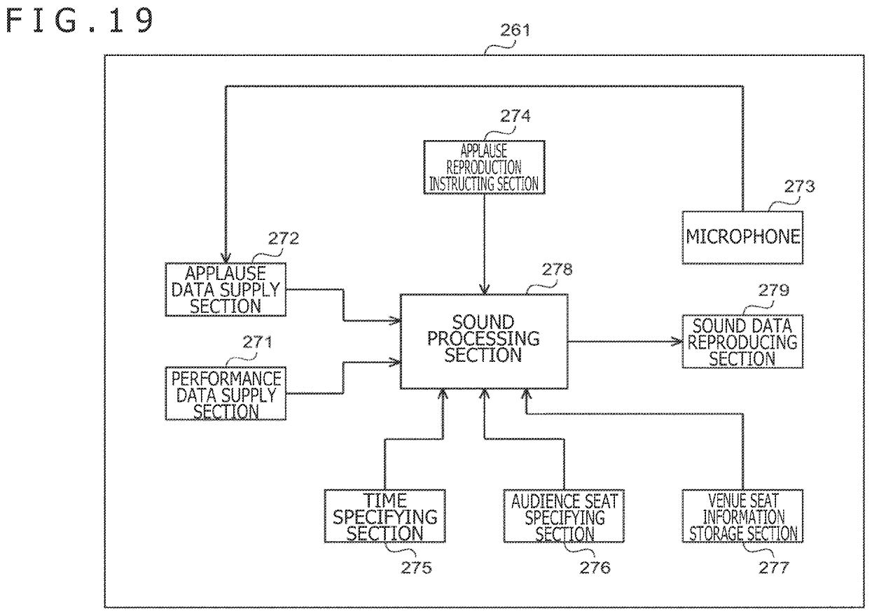

FIG. 19 is a block diagram depicting a configuration example of a sound reproducing apparatus that generates sound data to be provided to a user in the third concert mode.

A sound reproducing apparatus 261 in FIG. 19 has a performance data supply section 271, an applause data supply section 272, a microphone 273, an applause reproduction instructing section 274, a time specifying section 275, a listening seat specifying section 276, a venue seat information storage section 277, a sound processing section 278, and a sound data reproducing section 279.

The performance data supply section 271 is built by using a constituent element of the concert organizer server. The performance data supply section 271 supplies performance data obtained by recording the performance of a performer during a concert to the sound processing section 278 built by using a constituent element of a VR apparatus such as an HMD (Head Mounted Display) used by being worn by a user (or a processing apparatus connected to the VR apparatus). The server and the VR apparatus are connected communicatively via a communication network such as the Internet, performance data from the performance data supply section 271 to the sound processing section 278 is transmitted through the communication network. The VR apparatus may be an apparatus with which only sounds can be listened to.

In a case where the performance of a concert is distributed in real time, the performance data supply section 271 supplies, to the sound processing section 278, performance data that is obtained approximately simultaneously with the performance approximately in real time. In a case where performance data that is recorded in advance is distributed, the performance data supply section 271 supplies, to the sound processing section 278, performance data from the start to the end of a concert stored on the storage section according to a lapse of time.

The applause data supply section 272 is built by using a constituent element of the concert organizer server. The applause data supply section 272 supplies, to the sound processing section 278, applause data of voice generated by each user viewing and listening to a virtual concert. The applause data is transmitted to the VR apparatus of each user from the server through the communication network, similarly to the performance data.

The applause data of each user is sensed with the microphone 273 arranged for the user, the seat number of a virtual seat allocated to the user is added to the applause data, and the applause data is supplied to the applause data supply section 272 through the communication network.

The applause data supply section 272 supplies, to the sound processing section 278, applause data acquired from the microphone 273 of each user. Note that, similarly to the applause reproducing apparatus 131 in FIG. 12, applause data may be applause data obtained by a user recording her/his voice in advance before the start of a concert or the like, preset applause data of an artificially generated voice or preset applause data of the voice of a person not related to the user. In this case, header information in FIG. 8 is added to applause data.

The applause reproduction instructing section 274 is a processing section built by using a constituent element of the concert organizer server, and its processes are implemented in the server. The applause reproduction instructing section 274 supplies an applause reproduction start signal for instructing the sound processing section 278 to reproduce (emit) applause by using the sound data reproducing section 279. The applause reproduction start signal from the applause reproduction instructing section 141 to the sound reproduction processing section 144 is transmitted via wireless communication between the server and the VR apparatus of each user.

The applause reproduction start signal is supplied from the applause reproduction instructing section 274 to the sound processing section 278 for each applause period in which applause of an audience occurs during a concert. Since the applause periods are as mentioned above, explanations thereof are omitted.

Since a timing (time) at which the applause reproduction instructing section 274 transmits an applause reproduction start signal to the sound processing section 278, or a reproduction start time and reproduction duration specified by the applause reproduction start signal is/are similar to those of the applause reproducing apparatus 131 in FIG. 12, explanations thereof are omitted.

The time specifying section 275 is a timer mounted on a VR apparatus used by each user. The time specifying section 275 supplies times from the start time to the end time of the concert to the sound processing section 278.

The listening seat specifying section 276 is built by a constituent element of a VR apparatus used by each user. The listening seat specifying section 276 specifies, for the sound processing section 278, the seat number of a virtual seat in a virtual venue allocated to a user who uses the subject apparatus. A virtual seat in the virtual venue is allocated to each user before the start of a concert, and the seat number is notified to the user. The listening seat specifying section 276 acquires in advance the seat number of a virtual seat allocated to a user who uses the subject apparatus.

The venue seat information storage section 277 has stored thereon venue seat information representing the position of a stage at the virtual venue, the positions of virtual seats with respective seat numbers, seat ranges included in areas in a case where the virtual venue is divided into the areas, and the like. The venue seat information storage section 277 supplies the stored venue seat information to the sound processing section 278.

The sound processing section 278 is built by using a constituent element of a VR apparatus used by each user. However, the sound processing section 278 may be built by using a constituent element of a server. The sound processing section 278 mixes applause data together with performance data supplied from the performance data supply section 271, and causes the applause data to be output from the sound data reproducing section 279. The sound data reproducing section 279 is a sound reproducing apparatus such as a headphone or earphones.

The sound processing section 278 executes an applause reproduction process according to an applause reproduction start signal from the applause reproduction instructing section 274.

That is, when a time supplied from the time specifying section 275 matches a reproduction start time specified by the applause reproduction start signal, the sound processing section 278 starts an applause reproduction process. When a time supplied from the time specifying section 275 matches a time (reproduction end time) which is reproduction duration specified by the applause reproduction start signal after the reproduction start time, the sound processing section 278 stops (ends) the applause reproduction process.

In the applause reproduction process, the sound processing section 278 acquires, from the applause data supply section 272, applause data having, as a time code in header information, a reproduction start time specified by an applause reproduction start signal from the applause reproduction instructing section 274. In a case where the applause data supply section 272 supplies, in real time, applause data sensed at the microphone 273, the sound processing section 278 acquires applause data from the applause data supply section 272 during a period from a reproduction start time specified by the applause reproduction instructing section 141 until a reproduction end time specified by the applause reproduction instructing section 141. However, applause data acquired by the sound processing section 278 from the applause data supply section 272 may be limited to only applause data of users whose seat numbers of virtual seats which are within a predetermined distance from a virtual seat with a seat number specified by the listening seat specifying section 276, for example. The seat numbers of the virtual seats within the predetermined distance from the listening seat (virtual seat) specified by the listening seat specifying section 276 are identified on the basis of venue seat information stored on the venue seat information storage section 277.

The sound processing section 278 arranges, as object audio, applause data acquired from the applause data supply section 272 at the position of a virtual seat with a seat number added as header information to the applause data. The sound processing section 278 generates sound data of left and right sounds that will be listened to by the respective left and right ears by using a head-related transfer function or the like, supposing that sounds of applause data reproduced (emitted) from each object audio are propagated to the respective positions of the left and right ears at the position of a listening seat of a user who uses the subject apparatus as a listening position. Thereby, the sound processing section 278 generates applause data as virtual sounds or virtual sounds (stereophonic sounds) in which sound images are localized. Note that the sound processing section 215 reproduces applause data by object audio from a reproduction start time specified by the applause reproduction instructing section 212 until a reproduction end time which is reproduction duration specified by the applause reproduction instructing section 212 after the reproduction start time, and generates left and right sound data (applause data) at listening positions. The sound processing section 278 mixes the generated left and right applause data together with performance data, and supplies the sound data to the sound data reproducing section 279.

The sound data reproducing section 279 is a sound reproducing apparatus such as a headphone or earphones worn on both ears of each user. The sound data reproducing section 279 reproduces sound data (the performance data and the applause data) from the sound processing section 278, and provides the sound data to the user.

The sound reproducing apparatus 261 mentioned above is built for a VR apparatus arranged at home or the like of each audience member who views and listens to the third concert mode (virtual concert) as a concert distributed via a communication network or the like. Accordingly, each user can listen to virtual sounds of applause of an audience as viewed and listened to when the user views and listens to the concert at the position of a virtual seat allocated to the user.

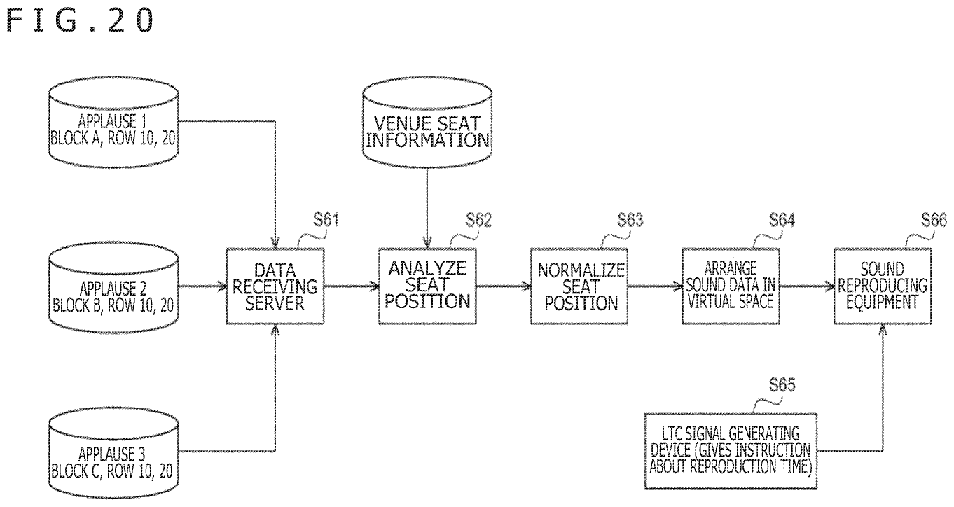

FIG. 20 is a figure for explaining a processing procedure of the virtual sound generation in FIG. 18.

At Step S61, the data receiving server (concert organizer server) collects applause data of a user allocated to each seat at a virtual concert venue in the third concert mode.

At Step S62, a virtual sound generating apparatus (sound reproducing apparatus 261) analyzes a seat position at a virtual concert venue on the basis of a seat number (seat information) included in header information of the applause data collected at Step S61. At this time, the virtual sound generating apparatus refers to venue seat information representing a relation between seat numbers and seat positions of respective seats of the virtual concert venue.

At Step S63, the virtual sound generating apparatus normalizes seat positions. For example, normalization means mixing applause data of 0.7 million people into applause data with the scale of 70 thousand people, scaling up the virtual space depending on the number of users (the volume of applause) or changing the density of virtual seats depending on the number of viewers/listeners.

At Step S64, the virtual sound generating apparatus arranges each piece of applause data collected at Step S61 in the virtual concert venue (virtual venue). At this time, each piece of applause data is arranged at a virtual seat position allocated to a user.

At Step S65, the virtual sound generating apparatus specifies a reproduction time by generating an LTC signal.

At Step S667, the virtual sound generating apparatus reproduces each piece of applause data at the time represented by the LTC signal generated at Step S65 in the virtual space (virtual venue), and generates a sound at a listening position (the seat position of a user) set in the virtual space.

The virtual sound generation mentioned above allows each user to listen to applause of an audience or performance according to the seat position in a virtual venue allocated to the user. Performers can listen to applause of an audience that sounds real by listening to virtual sounds of applause generated by treating their own positions as listening positions, by using ear monitors or the like.

The present technology can also be implemented in such following configurations.
(1)
   An information processing apparatus including:
   a communication section that communicates with a second apparatus that is able to control multiple recording apparatuses simultaneously;
   a recording section that is controlled by the second apparatus, and is able to perform recording in synchronization with the multiple recording apparatuses; and
   a processing section that adds, to sound data recorded by the recording section, positional information regarding a position where the sound data has been recorded and time information regarding a time when the sound data has been recorded.
(2)
   The information processing apparatus according to (1) above, in which the processing section adds, to the sound data and as the positional information, seat information that identifies a position of a seat installed at a venue.
(3)
   The information processing apparatus according to (2) above, in which the processing section adds a seat number of the seat as the seat information to the sound data.
(4)
   The information processing apparatus according to (2) or (3) above, in which the processing section acquires the seat information from a tag installed at the seat.
(5)
   The information processing apparatus according to any one of (2) to (4) above, in which the processing section adds, to the sound data, a song title that is being performed at the venue when the sound data is being recorded.
(6)
   The information processing apparatus according to any one of (1) to (5) above, in which the processing section adds, to the sound data, vibration information related to vibrations of the recording section.
(7)
   The information processing apparatus according to any one of (1) to (6) above, in which the recording section starts recording of the sound data on the basis of a recording start instruction acquired from the second apparatus by the communication section.
(8)
   The information processing apparatus according to any one of (1) to (7) above, further including:
   a light-emitting section that is controlled to emit light by the second apparatus.
(9)
   The information processing apparatus according to any one of (1) to (8) above, further including:
   a sound reproducing section that is controlled by the second apparatus, and reproduces sound data.
(10)
   An information processing method of an information processing apparatus including a communication section, a recording section, and a processing section, in which
   the communication section communicates with a second apparatus that is able to control multiple recording apparatuses simultaneously,
   the recording section is controlled by the second apparatus, and performs recording in synchronization with the multiple recording apparatuses, and
   the processing section adds, to sound data recorded by the recording section, positional information regarding a position where the sound data has been recorded and time information regarding a time when the sound data has been recorded.
(11)
   An information processing apparatus including:
   a communication section that communicates with a second apparatus that is able to control multiple reproducing apparatuses simultaneously; and
   a sound reproducing section that is controlled by the second apparatus, and reproduces sound data in synchronization with the multiple reproducing apparatuses.
(12)
   The information processing apparatus according to (11) above, in which the sound reproducing section reproduces pre-recorded sound data of a user.
(13)
   The information processing apparatus according to (11) or (12) above, in which the sound reproducing section reproduces sound data corresponding to a time for which the second apparatus has given an instruction for reproduction.
(14)
   The information processing apparatus according to any one of (11) to (13) above, in which the sound reproducing section is arranged at a position of a seat installed at a venue.
(15)
   The information processing apparatus according to any one of (11) to (14) above, in which
   the multiple reproducing apparatuses and the sound reproducing section are arranged at predetermined positions of a venue in a virtual space,
   the information processing apparatus further including a generating section that generates sound data that reproduces a sound as would be listened to when sound data that each of the multiple reproducing apparatuses reproduces at a position of the reproducing apparatus is listened to at a position where the sound reproducing section is arranged.
(16)
   The information processing apparatus according to (15) above, in which the generating section reproduces the sound data of the multiple reproducing apparatuses in predetermined order from a seat position of a predetermined start point of the venue by using information regarding seat positions in the venue where the multiple reproducing apparatuses perform reproduction.
(17)
   The information processing apparatus according to any one of (11) to (16) above, including:
   a light-emitting section that is controlled to emit light by wireless communication.
(18)
   An information processing method of an information processing apparatus including a communication section and a sound reproducing section, in which
   the communication section communicates with a second apparatus that is able to control multiple reproducing apparatuses simultaneously, and
   the sound reproducing section is controlled by the second apparatus, and reproduces sound data in synchronization with the multiple reproducing apparatuses.

### REFERENCE SIGNS LIST

1: Venue production system
11: Child device
12: Parent device
22: Light-emitting section
25: Speaker
26: Microphone
33, 61: Control section
36: Storage section
62: Communication section

1. An information processing apparatus comprising:
a communication section that communicates with a second apparatus that is able to control multiple recording apparatuses simultaneously;
a recording section that is controlled by the second apparatus, and is able to perform recording in synchronization with the multiple recording apparatuses; and
a processing section that adds, to sound data recorded by the recording section, positional information regarding a position where the sound data has been recorded and time information regarding a time when the sound data has been recorded.

2. The information processing apparatus according to claim 1, wherein the processing section adds, to the sound data and as the positional information, seat information that identifies a position of a seat installed at a venue.

3. The information processing apparatus according to claim 2, wherein the processing section adds a seat number of the seat as the seat information to the sound data.

4. The information processing apparatus according to claim 2, wherein the processing section acquires the seat information from a tag installed at the seat.

5. The information processing apparatus according to claim 2, wherein the processing section adds, to the sound data, a song title that is being performed at the venue when the sound data is being recorded.

6. The information processing apparatus according to claim 1, wherein the processing section adds, to the sound data, vibration information related to vibrations of the recording section.

7. The information processing apparatus according to claim 1, wherein the recording section starts recording of the sound data on a basis of a recording start instruction acquired from the second apparatus by the communication section.

8. The information processing apparatus according to claim 1, further comprising:
a light-emitting section that is controlled to emit light by the second apparatus.

9. The information processing apparatus according to claim 1, further comprising:
a sound reproducing section that is controlled by the second apparatus, and reproduces sound data.

10. An information processing method of an information processing apparatus including a communication section, a recording section, and a processing section, wherein
the communication section communicates with a second apparatus that is able to control multiple recording apparatuses simultaneously,
the recording section is controlled by the second apparatus, and performs recording in synchronization with the multiple recording apparatuses, and
the processing section adds, to sound data recorded by the recording section, positional information regarding a position where the sound data has been recorded and time information regarding a time when the sound data has been recorded.

11. An information processing apparatus comprising:
a communication section that communicates with a second apparatus that is able to control multiple reproducing apparatuses simultaneously; and
a sound reproducing section that is controlled by the second apparatus, and reproduces sound data in synchronization with the multiple reproducing apparatuses.

12. The information processing apparatus according to claim 11, wherein the sound reproducing section reproduces pre-recorded sound data of a user.

13. The information processing apparatus according to claim 11, wherein the sound reproducing section reproduces sound data corresponding to a time for which the second apparatus has given an instruction for reproduction.

14. The information processing apparatus according to claim 11, wherein the sound reproducing section is arranged at a position of a seat installed at a venue.

15. The information processing apparatus according to claim 11, wherein
the multiple reproducing apparatuses and the sound reproducing section are arranged at predetermined positions of a venue in a virtual space,
the information processing apparatus further including a generating section that generates sound data that reproduces a sound as would be listened to when sound data that each of the multiple reproducing apparatuses reproduces at a position of the reproducing apparatus is listened to at a position where the sound reproducing section is arranged.

16. The information processing apparatus according to claim 15, wherein the generating section reproduces the sound data of the multiple reproducing apparatuses in predetermined order from a seat position of a predetermined start point of the venue by using information regarding seat positions in the venue where the multiple reproducing apparatuses perform reproduction.

17. The information processing apparatus according to claim 11, comprising:
a light-emitting section that is controlled to emit light by wireless communication.

18. An information processing method of an information processing apparatus including a communication section and a sound reproducing section, wherein
the communication section communicates with a second apparatus that is able to control multiple reproducing apparatuses simultaneously, and
the sound reproducing section is controlled by the second apparatus, and reproduces sound data in synchronization with the multiple reproducing apparatuses.
